(19) United States
(12) Patent Application Publication
(10) Pub. No.: US 2003/0232600 A1
(43) Pub. Date: Dec. 18, 2003

(54) Passive intermodulation interference control circuits

(76) Inventors: James P. Montgomery, Marietta, GA (US); Donald L. Runyon, Duluth, GA (US); James Crawford Carson, Sugar Hill, GA (US); Bisser N. Dimitrov, Duluth, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 10/390,987

(22) Filed: Mar. 17, 2003

Related U.S. Application Data
(60) Provisional application No. 60/365,399, filed on Mar. 18, 2002.

(51) Int. Cl. H04B 1/40

(52) U.S. Cl. 455/67.11; 455/77; 455/562.1

(57) ABSTRACT

Passive intermodulation interference control circuits constructed from distributed elements of defined length and impedance segments of transmission media. The distributed elements can be combined with conventional discrete elements, such as resistors, to create a passive circuit that can be tuned to have a desired frequency response by selecting the size, length and position of the distributed elements. That is, the complete PIM interference control circuit is typically constructed from a combination of discrete and distributed elements and directly connected to or within the transmission media carrying the analog electromagnetic energy through a continuous extension of the transmission media. As such, the PIM interference control circuit can be located very close to the source of the PIM interference, such as the antenna's power divider. When strategically located in this position, the PIM circuit controls the intermodulation interference right at the source, before it enters the electronics of the receiver.

### CROSS-REFERENCE TO RELATED APPLICATIONS

This application claims priority to commonly-owned U.S. Provisional Patent Application Serial No. 60/365,399 entitled “PIM Reduction Networks For Wireless Applications” filed Mar. 18, 2002.

### TECHNICAL FIELD

The present invention relates to communication systems, and more particularly relates to passive intermodulation (PIM) interference control circuits for use in a wide range of communication systems, including wireless, mobile telephone, satellite and other data communication systems that employ multiple communication frequencies.

### BACKGROUND OF THE INVENTION

Intermodulation (“IM”) products are generated whenever communication signals are transmitted or received using two or more frequencies. Generally, intermodulation products consist of linear combinations of the harmonics associated with the carrier frequencies. Intermodulation becomes an interference problem when the intermodulation products generated fall in the pass band of a receiver operating nearby and the products have a signal amplitude that can degrade the communication system performance. Intermodulation products developed from the interaction of passive structures or devices and radio-frequency (“RF”) signal power is known as passive intermodulation, or “PIM.” In general, PIM is only a matter of concern when the available RF signal power is of a level suitable for transmitting a signal by radiation means using an antenna. PIM generated products can be associated with materials, structures, devices or components in the direct RF path or can be associated with any object subjected to strong RF field energy.

A non-linear distortion of signals occurs when the current and voltage are not linearly proportional at a point or region of the RF path. The RF path can be an obvious direct and often intended route for RF energy flow or the RF path can include coupling to nearby objects and structures interior and/or exterior to an RF device or component of a RF system. These non-linear characteristics can produce harmonic products, which can generally combine to produce intermodulation products occurring at linear combinations of the harmonic frequencies of the underlying carrier signals. Harmonic products occur at frequency values which are integer multiples of the fundamental carrier signal frequencies. The harmonic products can occur at frequency values that are both odd and even value multiples of the carrier signal frequencies. Intermodulation products are distinguished from harmonic products by occurring at frequency values that are linear combinations of fundamental and harmonic products frequency values. Intermodulation products, by their very nature of stemming from a plurality of signals, are sometimes called “mixing products.” The degree of non-linear behavior of any material, structure, or device can depend on the RF signal amplitude and generally the non-linearity can increase with the applied RF field or signal amplitude. The production of intermodulation products can be a particularly complex outcome of a large number of contributing parameters.

These non-linear characteristics can occur from particular materials in the RF path, fine structure resulting from the manufacture of combinations of otherwise substantially linear materials, corrosion, imperfections in physical contact between materials, or a host of other means. The use of materials having known non-linear RF signal characteristics is generally avoided in the design of electromagnetic transmission systems supporting multiple communication signals of large signal amplitude suitable for transmitting a signal by radiation by an antenna. Known materials having non-linear RF signal characteristics can include, but are not limited to, the general classes of conductors, semi-conductors, and dielectric materials. The control of PIM generation in communication systems susceptible to the products as a source of interference begins with the equipment design including material selection, manufacturing processes, assembly techniques and processes, and can extend to details associated with the equipment maintenance over the service life period. An example of a design technique used to control passive intermodulation generation is the U.S. Pat. No. 5,757,246 to Johnson where a method and apparatus for suppressing the generation of PIM is described for the use of an insulating dielectric sheet between two conductors forming a junction across which RF energy can flow to avoid direct contact that may otherwise produce PIM.

Commercially feasible applications for PIM control are presently limited to a predefined range of parameters for the RF power in systems in which a high degree or level of interference from intermodulation products is experienced. In other words, the practicable applications for PIM interference reduction technologies in RF system are presently bounded by the operational parameters of the communication system and economical practicalities. However, more cost effective PIM interference control technologies might make a wider range of applications commercially feasible. For example, PIM interference reduction might allow the deployment of commercially feasible options for modifying existing systems to use higher levels of RF transmit signal power, additional RF carrier frequencies, and lower levels of detectable RF receive signal power than are currently obtainable due to PIM interference. In general, more cost effective PIM interference reduction technologies would often allow the host communication system to utilize a higher transmit power level, a larger number and range of signal carriers, and a lower level of received power than would be possible in the absence of the PIM interference reduction technology. Therefore, a wide range of communications systems and applications could benefit from more effective and less costly PIM interference reduction technologies.

Generally, PIM product levels are not regulated by an agency such as the United States Federal Communications Commission (FCC) because the levels resulting from passive devices are below the spurious emission limits of a communication system. However, PIM product levels are generally a concern to the equipment manufacturer and communication service organization to control sources of interference that can degrade or possibly limit the quality and capacity of the service. Further, the present concern with PIM interference is presently concentrated in technologies using equipment and services with duplex operations of transmitting RF signals and receiving RF signals that are low in signal amplitude relative to the transmitting RF signals.

Nevertheless, it should be understood that PIM interference reduction technologies in general may be applicable to a wide range of applications, including any system in which significant levels of PIM interference occur. In particular, any non-linear RF signal characteristic in the physical transmission media or path supporting analog signal propagation produces a degree of PIM distortion in the carrier signal. Such non-linear signal characteristics, although small, will necessarily be created at any coupling in the transmission media, at any interface between two different transmission media, and so forth.

For example, a typical passive antenna along with its input connector or RF interface, power divider, radiating elements, and all other RF path connective elements can produce a degree or level of PIM products that can be a source of interference if the same or a nearby antenna is used for receiving RF signals: PIM products are typically recognized as a low-level signal distortion and can be viewed as a noise or interference source generated by the system, or the antenna as in this particular example. This is a natural byproduct of transmitting multiple signals through any type of physical media, which inherently generates low levels of PIM products as the media conveys and manipulates the transmitted energy. In many medium or low power communication systems, any impairment to the system is negligible and the interference created by PIM products occurs at an acceptable level either because it is small enough in amplitude or isolated enough from a receive signal path that it does not significantly degrade performance. In many high-power communications systems, however, the PIM interference occurring with the reception bands of the system can be significant, and therefore warrants further analysis and techniques for controlling, and preferably reducing or eliminating the interference within certain frequency ranges.

In particular, PIM interference can be significant enough to cause problems in systems utilizing two or more high-power transmission frequencies when the interference occurs within the operational receive bands of the same system. For example, a typical communication system may utilize two high-power transmission frequency bands and two reception frequency bands, which are often referred to as channels in a system using frequency division multiple access (FDMA). The same scheme can be referred to as a frequency division duplex (FDD) system. In these systems, the PIM generated interference created by the transmission frequencies that occurs within the reception bands can be a significant impairment to the communication system. Accordingly, considerable effort has been made to develop methods and systems for suppressing the PIM interference generated within a receive signal path or elsewhere in the communication system and enters a receive signal path with transmission frequencies within the reception bands.

In active devices that are naturally non-linear, such as solid-state power amplifiers (SSPAs), suppression circuits and feedback and feed forward techniques have been developed to counteract the production of harmonics and intermodulation. Such techniques and circuits are applied to effectively “linearize” a non-linear device's net performance characteristics within prescribed limits of operation and with particular operating characteristics. In general, these circuits themselves include active devices and analog circuitry. There are also known solutions that involve the generation and injection of RF signals at one or more harmonic frequency values of a fundamental carrier frequency value where the amplitude and phase of the injected signal is controlled in such a ways as to interfere with or cancel out a portion of the output signal containing a component signal resulting from a non-linear signal distortion in the amplifier. Nevertheless, any and all of these techniques and methods rely on the use of additional active circuitry and electrical power.

The present invention involves a solution to the general problem of removing one or more intermodulation products or signals after they are generated and have the capability of entering a receiver within a reception band of operation that. Solving this problem has previously been considered technically challenging, expensive, and often less than satisfactorily accomplished by conventional techniques. It would therefore be advantageous to find a way to control and/or suppress intermodulation products before they enter a receiver, and to accomplish this objective using passive circuitry. Accordingly, a need exists for improved methods and systems for controlling intermodulation interference. There exists a further need for passive intermodulation interference control circuits capable of reducing and preferably eliminating to satisfactory design standards the intermodulation interference occurring within the reception bands of a communication system. There exists a further need for passive intermodulation interference control circuits and methods that are effective and economically practical.

### SUMMARY OF THE INVENTION

The present invention meets the needs described above in passive intermodulation or “PIM” interference control circuits. These circuits effectively reduce passively created intermodulation products that can cause interference. The circuits may themselves be constructed from passive elements, and may therefore be located very near the source of the interference, such as near or within an antenna structure, without introducing significant new sources of PIM into the host communication system. As a result, passive PIM interference control circuits are often simpler to construct, more effective, subject to strategic placement, and less expensive to construct than known techniques and methods of improving the harmonic and intermodulation characteristics of active devices, such as solid state power amplifiers. Passive PIM control circuits may be advantageously designed to indirectly suppress intermodulation interference occurring within a desired band, such as the reception band of a communication system, by directly controlling out-of-band subject frequencies comprising one or more harmonic multiples of the transmission carrier frequencies. For example, controlling the out-of-band (i.e., frequencies outside the reception band) second harmonics of the transmission carrier frequencies is typically effective at suppressing the signal amplitude of intermodulation products occurring within the reception band without substantially attenuating the desired received signals present within the operational reception band.

Generally described, the present invention may be implemented as a PIM control circuit in or for a communication system that includes a transmission media carrying at least two analog transmission frequencies and at least one reception frequency band, and may be configured to control intermodulation interference associated with the transmission frequencies that occur within the reception frequency band. The PIM control circuit typically includes a number of distributed elements of defined length and impedance segments of transmission media that are electrically connected into a circuit having a desired frequency response. Additionally, discrete or lumped electrical elements, such as conventional resistors, capacitors and inductors, may be included in the circuits to aid in the design of the PIM control circuit to have a desired frequency response. In particular, resistive elements are preferably included in many PIM control circuit configurations.

The PIM control circuit is typically configured to indirectly control in-band intermodulation interference by directly controlling out-of-band subject frequencies comprising one or more harmonic multiples of the transmission carrier frequencies in an operational frequency band. In addition, the PIM control circuit may be advantageously located on a substrate carrying an antenna power divider directing the transmission frequencies carried on the transmission media to a plurality of antenna elements. For example, the transmission media may be microstrip, and the distributed elements may be constructed from segments of microstrip having a conductor width and length selected to exhibit desired impedance and phase characteristics.

In addition, the PIM control circuit may be directly connected to the communication system through a continuous extension of the transmission line media of the communication system. This interconnection technique generally minimizes the impedance of the connection between the PIM control circuit and the communication system, and avoids the introduction of additional sources of PIM, such as junctions between different types of transmission media. Nevertheless, other interconnection techniques may be desirable in certain situations. For example, a modular PIM control circuit may be constructed from microstrip transmission media and distributed elements constructed from defined widths and lengths of the same microstrip transmission media. The modular PIM circuit may also include microstrip-to-coaxial-cable junctions at both ends to facilitate easy connection of the circuit into a coaxial cable. The benefits of easy installation of such a circuit may outweigh creation of additional PIM at the junctions, and may therefore provide a cost effective alternative for many applications. In addition, like other PIM control circuits, these modular devices may optionally include one or more discrete elements, such resistors, capacitors and inductors. In particular, resistive elements are preferably included in many circuit configurations to absorb some or all of the power of out-of-band subject frequencies comprising one or more harmonic multiples of the transmission carrier frequencies.

However, it should be understood that the PIM control circuits of the present invention are not limited to microstrip media distributed elements, and generally may be constructed from any suitable type of distributed elements. For example, the distributed elements may be constructed from microstrip, air dielectric microstrip, stripline, coaxial cable, square-ax cable, waveguide, and any other suitable transmission media with or without one or more dielectric materials. The PIM control circuit may also include one or more discrete electrical elements, such as resistors, capacitors and inductors. At lower frequencies, for example below about 700 MHz, it may be advantageous to realize the PIM control circuit using either a combination of distributed and lumped elements, or in some cases with only lumped elements such as inductors, capacitors and resistors. Alternatively or in conjunction with conventional discrete electrical elements, the PIM control circuit can include distributed resistive elements, such as those constructed from a resistive type material distributed over a surface area or a volume, for example a resistive film or block of bulk RF absorbing material.

The PIM control circuit may implemented in any number of circuit configurations, such as a shunt configuration, a diplexer configuration, a multi-leg shunt configuration, a bi-directionally equivalent back-to-back shunt configuration, a bi-directionally equivalent back-to-back diplexer configuration, or any other configuration found to be effective for a desired purpose. Such a range of options allows the circuit designer to strategically choose the amount of harmonic signal control necessary for the PIM reduction for a specific configuration in view of the prevailing physical, operational and economic constraints.

The invention may also be embodied in an antenna system including a transmission media carrying at least two transmission carrier frequencies and one reception frequency, and a power divider connecting a plurality of antenna elements to the transmission media. The antenna system also includes a PIM control circuit connected to the antenna's transmission media and configured to indirectly control in-band intermodulation interference associated with the transmission frequencies that occur within the reception frequency band by directly controlling out-of-band subject frequencies, such as one or more harmonic multiples of the transmission frequencies. The PIM control circuit may include a number of distributed elements of defined length and impedance segments of transmission media that are electrically connected into a circuit having a desired frequency response. As noted previously, the PIM control circuit may advantageously be located on a dielectric substrate carrying conductors forming an antenna power divider directing the transmission frequencies carried on the transmission media to a plurality of antenna elements.

The invention may also be embodied as a method for designing a PIM control circuit for a communications system. At least two transmission carrier frequencies and a reception frequency band are identified for the communications system. In-band intermodulation frequencies associated with the transmission carrier frequencies occurring within the reception band are also identified. Out-of-band principal components of the intermodulation frequencies occurring outside an operational reception band are then identified, and-a PIM control circuit is designed for indirectly controlling the in-band intermodulation signals by directly controlling the out-of-band harmonic signals. The PIM control circuit typically includes distributed elements of defined length and impedance segments of transmission media that are electrically connected into a circuit having a desired frequency response, and may also include one or more discrete elements.

The invention may also be deployed as an improvement to an antenna system including a transmission media supplying transmission RF power in a plurality of transmission frequencies and receiving reception RF power in a reception frequency band. In this case, the improvement may include a PIM control circuit directly coupled to the transmission media through a continuous extension of the transmission media. The circuit may also include distributed elements constructed from segments of transmission media, and is preferably configured to control frequencies corresponding to one or more harmonic multiples of the transmission frequencies occurring outside the reception band in order to effect reduction of intermodulation interference occurring within the reception band.

In addition, the present invention need not be limited to communications systems. For example, the invention may be deployed generally as a passive interference suppression circuit including distributed elements constructed from segments of transmission media. The circuit is typically configured to indirectly suppress interference frequencies occurring within a desired band by directly suppressing identified subject components of the interference frequencies occurring outside the desired band. Typically, the interference frequencies include intermodulation interference resulting from a plurality of transmission frequencies, and the subject components include one or more harmonic multiples of the transmission frequencies. In particular, a passive interference suppression circuit including distributed elements constructed from segments of transmission media, and directly connected to a transmission media through a continuous extension, of the communications system's transmission media, is a preferred mode of practicing the invention. However, other design objectives appropriate to a particular application may be accomplished once the design techniques of the invention are understood.

In view of the foregoing, it will be appreciated that the present invention avoids the drawbacks of prior intermodulation interference reduction systems. The specific techniques and structures for passively suppressing intermodulation interference and thereby accomplishing the advantages described above, will become apparent from the following detailed description of the embodiments and the appended drawings and claims.

### BRIEF DESCRIPTION OF THE DRAWINGS

FIG. 1 is a block diagram of a communication system including a PIM control circuit located on the antenna side of a transmission media junction.

FIG. 1B is a functional block diagram of a communication system including a PIM control circuit located on the transmission line side of a transmission media junction.

FIG. 1C is a functional block diagram of a communication system including a PIM control circuit located adjacent to a signal generator.

FIG. 2 is a logic flow diagram illustrating a routine for designing and deploying a PIM control circuit to implement an embodiment of the present invention.

FIG. 3 is a functional block diagram of a communication system including a shunt PIM control circuit and illustrating absorptive and reflective techniques for controlling PIM subject frequencies.

FIG. 4 is a functional block diagram of a communication system including a multi-leg shunt PIM control circuit.

FIG. 5 is a functional block diagram of a communication system including a diplexer PIM control circuit.

FIG. 6 is a functional block diagram of a communication system including a back-to-back diplexer PIM control circuit.

FIG. 7 is a functional block diagram of a communication system including a back-to-back multi-leg shunt PIM control circuit.

FIG. 8 is a functional block diagram of a communication system including a back-to-back shunt-diplexer PIM control circuit.

FIG. 9A is a perspective view of an antenna including a PIM control circuit located on a common PC board substrate.

FIG. 9B is an exploded perspective view of the central portion of the antenna of FIG. 9A including the PIM control circuit.

FIG. 10A is a perspective view of the PIM control circuit including reference letters identifying physical components of the circuit.

FIG. 10B is a schematic diagram of the PIM control circuit of FIG. 10A including like reference letters identifying the schematic symbols corresponding to the physical components of the circuit.

FIG. 11A is a schematic diagram of a first exemplary control circuit.

FIG. 11B is a graph illustrating the frequency response of the exemplary control circuit shown schematically in FIG. 11A.

FIG. 12A is a schematic diagram of a second exemplary control circuit.

FIG. 12B is a graph illustrating the frequency response of the control circuit shown schematically in FIG. 21A.

FIG. 13A is a schematic diagram of a third exemplary PIM control circuit.

FIG. 13B is a graph illustrating the frequency response of the PIM control circuit shown schematically in FIG. 13A.

FIG. 14A is a schematic diagram of a fourth exemplary PIM control circuit.

FIG. 14B is a graph illustrating the frequency response of the exemplary PIM control circuit shown schematically in FIG. 14A.

FIG. 15A is a schematic diagram of a fifth exemplary PIM control circuit.

FIG. 15B is a graph illustrating the frequency response of the exemplary PIM control circuit shown schematically in FIG. 15A along with the intended fundamental and second harmonic frequency bands for the circuit.

FIG. 16A is a schematic diagram of a sixth exemplary PIM control circuit.

FIG. 16B is a graph illustrating the frequency response of the exemplary PIM control circuit shown schematically in FIG. 16A along with the intended fundamental and second harmonic frequency bands for the circuit.

FIG. 17A is a schematic diagram of a seventh exemplary PIM control circuit.

FIG. 17B is a graph illustrating the frequency response of the exemplary PIM control circuit shown schematically in FIG. 17A along with the intended fundamental and second harmonic frequency bands for the circuit.

FIG. 18A is a schematic diagram of an eighth exemplary PIM control circuit.

FIG. 18B is a graph illustrating the frequency response of the exemplary PIM control circuit shown schematically in FIG. 18A along with the intended fundamental and second harmonic frequency bands for the circuit.

FIG. 19A is a schematic diagram of a ninth exemplary PIM control circuit.

FIG. 19B is a graph illustrating the frequency response of the exemplary PIM control circuit shown schematically in FIG. 19A along with the intended fundamental and second harmonic frequency bands for the circuit.

FIG. 20A is a schematic diagram of a tenth exemplary PIM control circuit.

FIG. 20B is a graph illustrating the frequency response of the exemplary PIM control circuit shown schematically in FIG. 20A along with the intended fundamental and second harmonic frequency bands for the circuit.

FIG. 21A is a schematic diagram of an eleventh exemplary PIM control circuit.

FIG. 21B is a graph illustrating the frequency response of the exemplary PIM control circuit shown schematically in FIG. 21A along with the intended fundamental and second harmonic frequency bands for the circuit.

FIG. 22A is a schematic diagram of a twelfth exemplary PIM control circuit.

FIG. 22B is a graph illustrating the frequency response of the exemplary PIM control circuit shown schematically in FIG. 22A along with the intended fundamental and second harmonic frequency bands for the circuit.

FIG. 23A is a schematic diagram of a thirteenth exemplary PIM control circuit.

FIG. 23B is a graph illustrating the frequency response of the exemplary PIM control circuit shown schematically in FIG. 23A along with the intended fundamental and second harmonic frequency bands for the circuit.

FIG. 24A is a schematic diagram of a fourteenth exemplary PIM control circuit.

FIG. 24B is a graph illustrating the frequency response of the exemplary PIM control circuit shown schematically in FIG. 24A along with the intended fundamental and second harmonic frequency bands for the circuit.

FIG. 25A is a schematic diagram of a fifteenth exemplary PIM control circuit.

FIG. 25B is a graph illustrating the frequency response of the exemplary PIM control circuit shown schematically in FIG. 25A along with the intended fundamental and second harmonic frequency bands for the circuit.

FIG. 26A is a schematic diagram of a sixteenth exemplary PIM control circuit.

FIG. 26B is a graph illustrating the frequency response of the exemplary PIM control circuit shown schematically in FIG. 26A along with the intended fundamental and second harmonic frequency bands for the circuit.

FIG. 27A is a schematic diagram of a seventeenth exemplary PIM control circuit.

FIG. 27B is a graph illustrating the frequency response of the exemplary PIM control circuit shown schematically in FIG. 27A along with the intended fundamental and second harmonic frequency bands for the circuit.

FIG. 28A is a schematic diagram of a eighteenth exemplary PIM control circuit, this example including discrete resistors and capacitors as well as distributed transmission media elements.

FIG. 28B is a graph illustrating the frequency response of the exemplary PIM control circuit-shown schematically in FIG. 28A along with the intended fundamental and second harmonic frequency bands for the circuit.

FIG. 29A is a graph illustrating the measured third order intermodulation (IM3) frequency response of the antenna shown in FIGS. 29A-B and 10A-B measured at a first antenna interface with and without the PIM control circuit shown in those diagrams connected to the antenna feed circuit.

FIG. 29B is a graph illustrating the measured third order intermodulation (IM3) frequency response of the antenna shown in FIGS. 9A-B and 10A-B measured at a second antenna interface with and without the PIM control circuit shown in those diagrams connected to the antenna feed circuit.

### DETAILED DESCRIPTION OF THE EMBODIMENTS

Briefly described, the invention may be embodied in a passive intermodulation (“PIM”) interference control circuit constructed from distributed elements consisting of defined length and impedance segments of transmission- media. The distributed elements are often combined with conventional discrete elements, such as resistors, capacitors and inductors, to construct passive circuits that can be tuned to have a desired frequency response by selecting the width, length and position of the distributed elements. In addition, the complete PIM interference control circuit is typically constructed from a combination of discrete and distributed elements, and is typically directly connected to or within the transmission media carrying the RF electromagnetic energy through a continuous extension of the transmission media. As such, the PIM interference control circuit can be physically located very close to, and directly connected to, a source of the PIM interference such as the RF input connection or an antenna array's power divider. When strategically located and connected in this manner, the PIM circuit controls the intermodulation interference near a source, before it enters the electronics of the receiver.

Further exploration of the techniques for designing PIM interference control circuits will be facilitated by an explanation of the fundamental principles at work in generating and controlling intermodulation, as recognized by the inventors. Fully appreciating the underlying phenomena leads directly and indirectly to a wide range of PIM circuit designs and design techniques. It should be appreciated that, to the knowledge of the inventors, the type of circuit design developed by the inventors for PIM suppression utilizing distributed elements consisting of defined length and impedance segments of transmission media, sometimes in combination with discrete elements such as resistors, capacitors and inductors, has never been attempted or perfected prior to the present invention. As such, this type of circuit design appears to be an entirely new category of circuitry, and its application to PIM interference reduction the first useful mode of practicing this promising new technology.

As one exemplary application of the technology, the operational band of a frequency division multiple access (FDMA) communications system can encompass a transmit frequency band and separate a receive frequency band. A communications system can also be duplex so that transmit and receive operations can be complementary, and the role of a specific sub-band within the operational band can depend upon which portion of a communication link the functional operation occurs. For example, the US PCS base station (BS) licensed transmit band is 1930 to 1990 MHz and the BS licensed receive band is 1850 to 1910 MHz. The mobile unit functional bands are complementary and the 1850 to 1910 MHz band is the transmit band and the 1930 to 1990 MHz band is the receive band. A person of ordinary skill in the art will understand that a repeater system can have both complementary portions in operation at a single site or location.

The operation band can be defined by it's sub-band portions used for transmit and/or receive functions are typically referred to as “in-band” whereas frequencies not contained within these sub-band portions are typically called “out-of-band”. In other words, out-of-band frequency values generally refer to the frequencies outside the operational frequency bands of the communication system. For example, the carrier frequencies for a transmit functional operation at a site, station or unit can define an in-band set of frequencies and the frequencies for a receive functional operation can likewise be defined as an in-band set of frequencies. In order to avoid in-band interference directly from the harmonics of the carrier frequencies, it is known to set the frequency range of the receive band below a frequency that is twice the lower limit of the transmit frequency band, which causes all of the integer-multiple harmonics of the carrier frequencies to occur out-of-band. Nevertheless, significant levels of PIM interference may still be experienced in-band. The PIM control circuits and design techniques of the present invention may be used to address this problem.

Further examination into the fundamentals underlying intermodulation interference reveals that electromagnetic energy exhibits the phenomenon of creating interference in one or more harmonic multiples of the underlying carrier frequencies. In addition, the amplitude and corresponding energy within the harmonics generally tends to decrease as the order of the harmonic increases. Thus, the second harmonic (i.e., twice the carrier frequency) is typically the largest harmonic, followed by the third harmonic, the fourth harmonic, and so forth. Although there may be some anomalies, for example even harmonics being significantly higher (or lower) than odd harmonics across the spectrum, the general trend of decreasing energy as the order of the harmonic increases is generally an inherent property of harmonic distortion. It has also been determined that harmonics present in multiple frequencies can occur in other combinations, which produces intermodulation interference frequencies in linear combinations of the harmonics and fundamental frequencies present. For example, in a system with f₁ and f₂ referring to two carrier frequencies, both simple harmonics of the carrier frequencies and the following linear combination intermodulation frequencies are typically present:

2f₁+f₂; 2f₁−f₂; 3f₁+f₂; 3f₁−f₂; 3f₁+2f₂; 3f₁−2f₂; etc.

2f₂+f₁; 2f₂-f₁; 3f₂+f₁; 3f₂−f₁; 3f₂+2f₁; 3f₂−2f₁; etc.

Within these harmonic frequencies and intermodulation product frequencies, as noted above, the second harmonic elements (i.e., 2f₁ and 2f₂) are usually the largest in power and signal amplitude. In addition, certain linear combinations of harmonics including the second harmonic elements may occur within the operational reception band of the system. Specifically, the following intermodulation frequencies are often the most likely sources of interference within the reception bands: 2f₁−f₂; and 2f₂-f₁. Of course, the actual intermodulation frequencies occurring in-band will vary from system to system, and may be revealed by analyzing the particular system transmitting and receiving operational bands.

A difficulty arises when attempting to suppress in-band intermodulation interference because the interfering frequencies are, by definition, within the operational reception band. In other words, the interfering frequencies that the system designers would like to suppress occur within the same channel as the signals that they do not want to suppress, i.e., the reception band. Therefore, any control circuit or filter that attenuates the in-band interference necessarily affects the desired signals in the reception band, usually in an adverse manner.

The solution recognized by the developers of the present technology involves recognizing that the in-band intermodulation frequencies include primary components that are typically one or more out-of-band harmonics of the underlying carrier frequencies. In other words, the in-band intermodulation frequency causing the disruptive interference, such as 2f₁−f₂; and 2f₂−f₁, can be effectively suppressed by controlling the amplitude and perhaps the phase of the out-of-band primary harmonic elements, in this case 2f₁ and 2f₂. These frequencies are referred to as the “PIM subject frequencies” because, once they have been identified, a PIM interference control circuit may be designed to directly control these out-of-band harmonics in such a way as to minimize the interfering PIM without adversely affecting the reception of the desired in-band signals. It will be understood by those skilled in the art that such an interference reduction technique will have many advantages over attempting to apply in-band filtering to suppress the in-band interference once it enters a receiver or other piece of electronic equipment.

From a mathematical viewpoint, intermodulation is the production, in a nonlinear element of a system, of signals having frequencies corresponding to the sum and difference frequencies of the fundamentals and harmonics that are transmitted through the element. Intermodulation occurs whenever radio frequency signals at two or more frequencies are simultaneously present in a conductor of radio frequency energy. Every radio frequency device generates some degree of intermodulation products when more than one frequency is present in the device. Whether these products cause interference in the system depends on a number of factors, including the signal amplitude level of the products, the frequencies of the products, the receive pass band characteristics, and the isolation of the receive signal paths from the generating sources of the intermodulation products, and the like.

A communication system can have an operational band comprised of a sub-band for the transmit (Tx) band of frequencies from a point in the system and a sub-band for the receive (Rx) band of frequencies from the same point such as a base station (BS) in a mobile communication system. A system having separate transmit and receive bands is conventionally called a frequency division duplex (FDD) type system. A different point in the system, such as a mobile telephone or mobile subscriber, can have the respective BS transmit and receive sub-bands operationally reversed in order to communicate with the BS. By example, the PCS system in the United States is an FDD type system having a licensed frequency allocation of 1930 to 1990 MHz for the transmit band and 1850 to 1910 MHz for the receive band of the BS. Intermodulation products can be a source of interference within the receive band of the system and can be a source of interference for other systems having different operational bands. The generation of PIM products is in general more of a concern at a point in a communication system having relatively high power signals such as in a base station of a mobile communication system.

A communication system operating transmit and receive functions within the same band of frequencies by using time division to separate transmit and receive is conventionally called a time division duplex (TDD) system. A TDD system can produce PIM as a source of interference to other communication systems operating in different frequency bands although the self-interference from PIM is much greatly reduced.

A simple polynomial approximation of intermodulation interference in a component of a system can describe the underlying principles by a current-voltage (i-v) relationship of the form:

i=g₁v+g₂v²+g₃v³+g₄v⁴+g₅v⁵+ . . .

and a composite carrier signal in the operational transmit band of frequencies can be given by the form:

v(t)=A₁ cos (ω₁t)+A₂ cos (ω₂t)+A₃ cos (ω₃t)+ . . . +Aᵢ cos (ωᵢt)

where ωᵢ=2πfᵢ and fᵢ represents the frequency in Hertz. If the input voltage is a single frequency waveform, only harmonics of that frequency will be evident in the output current waveform. However, if the input signal is comprised of at least two carrier frequencies, the output waveform is comprised of not only harmonics of the carrier's frequencies, but also products resulting from combinations of the carrier frequencies and their harmonics. By example, the intermodulation products for two carrier frequencies occur at non-negative frequencies given by: fᵢ=±nf₁±mf₂ and the order of the intermodulation product, O, is given as (n+m) where n and m are positive integer values. In cases such as the wireless PCS service, the transmit frequency band is located above the receive frequency band. Furthermore, the odd order values of intermodulation product frequencies:

fᵢ=2f₁−f₂,2f₂−fᵢ and 3f₁−2f₂, 3f₂−2f₁ and 4f₁−3f₂, etc

are located either below the lower of the two frequencies (f₁) or above the higher of the two frequencies (f₂) in constant multiples of the separation of the carriers (e.g. Δf=f₂−f₁ where f₂>f₁)

For example, if the carriers are at BS transmit frequencies 1940 MHz (a PCS A Band license) and 1980 MHz (a PCS C Band license), the above odd order intermodulation product frequencies occurring below the BS transmit frequencies are 110 given by:

fᵢ=2f₁−f₂=1900 MHz (a PCS C Band receive frequency)

and 3f₁−2f₂=1860 MHz (a PCS A Band receive frequency)

and 4f₁−3f₂=1820 MHz (below all PCS licensed bands)

Both the A and C receive bands are potentially degraded, depending on the magnitude of the intermodulation products.

Using the polynomial approximation up to the third (3^{rd}) order term, results in the following 3^{rd} order intermodulation products:

$$\begin{matrix}\frac{3}{4} {g}_{3} {A}_{1}^{2} {A}_{2} cos ( 2 {ω}_{1} - {ω}_{2} ) \\ \frac{3}{4} {g}_{3} {A}_{2}^{2} {A}_{1} cos ( 2 {ω}_{2} - {ω}_{1} )\end{matrix}$$

Additional third (3^{rd}) order intermodulation products will result if additional polynomial coefficients are used, however, these products Will all be progressively smaller due to the decreasing polynomial coefficient. However, the control of the harmonic response using passive networks close to the predominant source of intermodulation has been shown to have a beneficial effect on the signal amplitude of the intermodulation products. In the case of the third order products it has been observed that an absorptive filter operating on a second (2^{nd}) order harmonic product (2ωᵢ) can reduce the signal amplitude of the third (3^{rd}) order intermodulation products (2ω₂−ω₁, 2ω₁-ω₂). While the actual mechanism(s) at work in producing this observed benefit cannot be ascertained with certainty, it is believed that these networks operate by modifying the harmonic responses through absorption, reflective cancellation, or a combination of these techniques to effectively control the magnitude and phases of the net harmonic terms at or near the intermodulation source. This control using passive means as described in this patent capable of cancellation or minimization of the 3^{rd} order effect have been constructed and tested.

When higher order products (other than the 3^{rd} order just described) are the interfering terms, similar harmonic control can be applied for controlling and effectively eliminating the intermodulation terms in desired bands to acceptable design standards. Control mechanisms as described in the present invention are typically passive and involve networks including distributed elements constructed from distributed segments of transmission media selected to have desired lengths and impedances configured into a circuit having a desired frequency response, and introduced near the predominant source of intermodulation. The circuits typically include one or more resistive elements to absorb some or all of the power of out-of-band subject frequencies comprising one or more harmonic multiples of the transmission carrier frequencies, and may also include one or more discrete or “lumped” electrical elements, such as resistors, capacitors and inductors. These circuits are typically directly connected to the host communication system through a continuous extension of the transmission media of the communication system to provide a low impedance connection and avoid the introduction of new sources of PIM into the system.

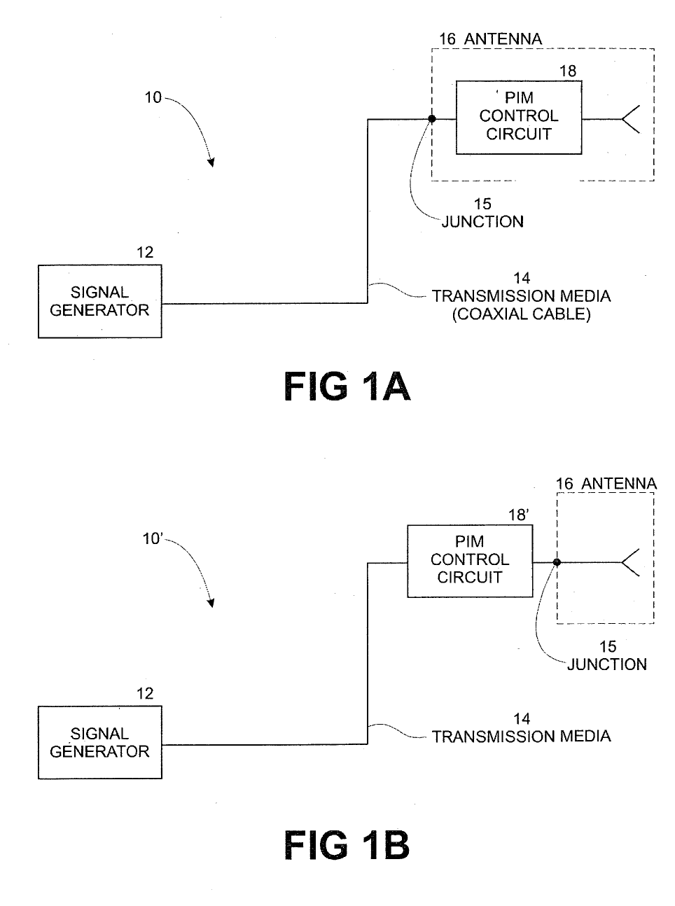

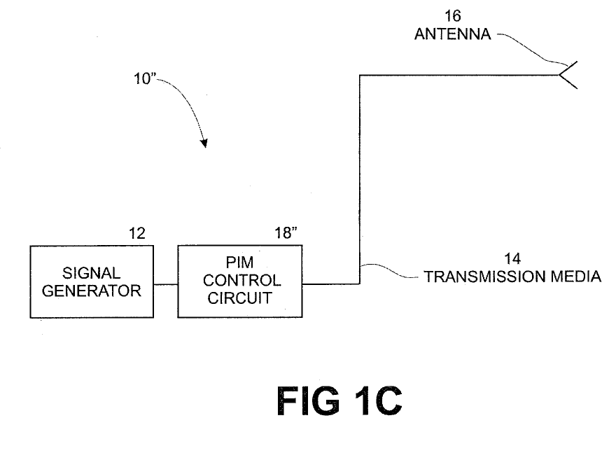

Turning now to the figures, in which similar reference numerals indicate similar elements in the several figures, FIGS. 1A-C illustrate three different physical locations where a PIM control circuit may be interconnected into a typical communication system. In particular, it may be advantageous in many applications to directly connect the PIM control circuit to the communication system through a continuous extension of the transmission line media of the communication system. For example, this interconnection technique allows the PIM circuit to be placed directly on or adjacent to the PC board substrate of a host antenna, and to be connected to the microstrip transmission media of the antenna through a continuous extension of the antenna's microstrip into the PIM control circuit. This direct interconnection technique generally minimizes the impedance of the connection between the PIM control circuit and the communication system, and avoids the introduction of additional sources of PIM into the system, such as junctions between different types of transmission media.

Nevertheless, other interconnection techniques may be desirable for connecting a PIM control circuit to a communication system. For example, a modular PIM circuit may be constructed from microstrip transmission media and distributed elements constructed from defined widths and lengths of the same microstrip transmission media. To make the circuit modular and removable, it may include microstrip-to-coaxial-cable junctions at both ends to facilitate easy connection of the circuit into a coaxial cable. The benefits of modular construction and easy installation of such a circuit may outweigh creation of additional PIM at the junctions, and may therefore provide a cost effective alternative for may applications. Other interconnection alternatives may become apparent for particular applications depending on the design objective, the cost limitations, and practicalities such as the availability of a solid RF ground, the need to provide maintenance access, the need for protection from the weather, lightening protection, and so forth. In view of these considerations, FIGS. 1A-C illustrate three likely, but certainly not all, interconnection locations that might be advantageous for different applications.

FIG. 1A is a functional block diagram of a communication system 10 including a signal generator (and receiver) 12, which injects communication signals into, and receives communication signals from, a transmission media 14, such as a coaxial cable or other suitable media. The transmission media 14, in turn, feeds the forward propagating communication signals through a junction 15 and to an antenna 16, which broadcasts the signals. For example, the junction 15 may be a coaxial-to-microstrip junction between a coaxial cable transmission media 14 and a microstrip transmission media of the antenna 16. Received signals also propagate through the system in the reverse direction. For the present illustration, the communication signals include at least two carrier frequencies that combine to produce passively-created intermodulation (PIM) products, as described previously. The transmission media 14 also typically carries received communication signals within at least one reception band, which may also be referred to as a frequency channel.

The PIM products can be a significant source of communication interference when they occur at frequencies within the reception band. This type of interference is referred to as “in-band” PIM. To remove or reduce the in-band PIM, the communication system 10 includes a passive PIM control circuit 18 designed to control the PIM with the objective of substantially reducing the in-band PIM to acceptable design standards. More specifically, the in-band PIM typically includes an intermodulation product that includes a principal harmonic component occurring outside the reception band. This component is therefore referred to as an “out-of-band” principal component of the in-band PIM, which is typically attributed to a harmonic of a transmission carrier frequency.

As described previously, the second harmonics of the transmission carrier frequencies are often identified as the principal out-of-band components of the in-band PIM interference. The PIM control circuit 18 is therefore designed to indirectly reduce the in-band PIM by directly reducing the principal out-of-band harmonic component of the in-band PIM. Even more specifically, the PIM control circuit 18 may be designed to reduce the principal out-of-band harmonic component of the in-band PIM by completely or partially absorbing this frequency component, for example by shunting it to ground through a resistor, or by canceling it out by controlling a reflected harmonic component to have approximately the same amplitude and an opposite phase as a forward propagating harmonic component. These two PIM control techniques are referred to as absorptive and reflective PIM control, respectively. PIM control circuits may be designed to employ absorptive PIM control, reflective PIM control, or a combination of these techniques.

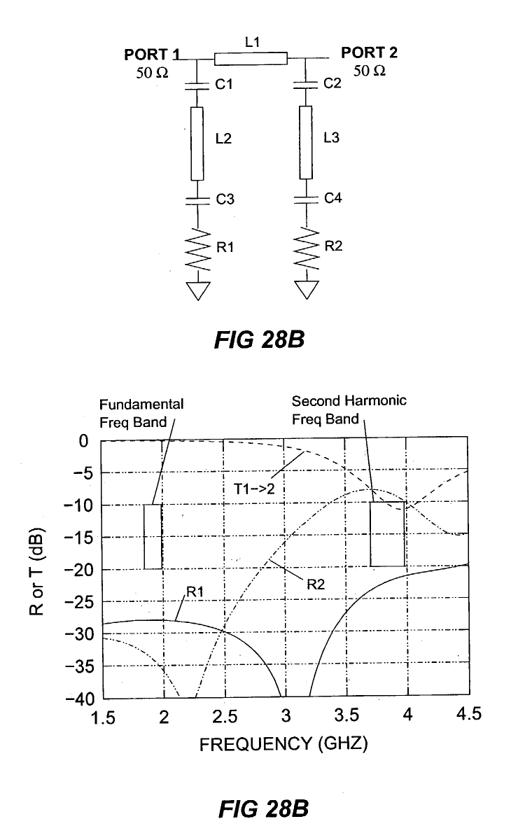

For a typical RF application, the transmission media 14 is a coaxial cable, and the antenna 16 includes a microstrip transmission media, which implements a power divider that delivers the transmitted communication signals to a number of antenna elements. For this type of application, the PIM control circuit 18 may be located on the antenna side of the coaxial-to-microstrip junction 15, as shown in FIG. 1A. In particular, the PIM control circuit 18 may be constructed on the same PC board substrate as the antenna 16, may be connected to the antenna microstrip transmission media through an unbroken extension of microstrip transmission media, and may include one or more distributed elements of defined length and impedance segments of microstrip transmission media that are electrically connected into a circuit having a desired frequency response. PIM control circuits deployed in this manner have produced substantial reductions of in-band PIM in field tests. See FIGS. 28A-B and the accompanying text for the actual field test results of a PIM control circuit.

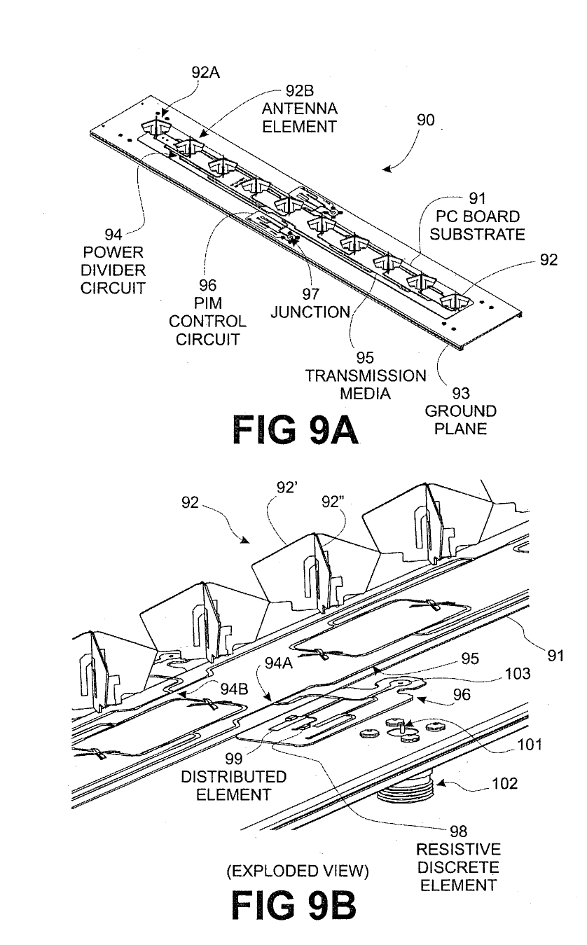

However, it should also be appreciated that PIM control circuit may be deployed in a wide range of other configurations and locations. For example, the PIM control circuit may be located on a secondary or daughter PC board rather than on the PC board substrate supporting the antenna itself. In addition, the transmission media 14 may be another type of transmission media, such as air dielectric microstrip, stripline, coaxial cable, square-ax cable, waveguide, and any other suitable transmission media with or without one or more dielectric materials. Similarly, the distributed elements of the PIM control circuit 18 may be constructed from defined length and impedance segments of these other types of transmission media. Further, the PIM control circuit 18 may include discrete elements, such as resistors, capacitors and inductors in addition to the distributed elements. For a new antenna application, it is believed that an on-board PIM circuit, such as that shown in FIGS. 9A-B and 10A-B, may be designed to exhibit superior performance for in-band PIM reduction, and may also be the most cost effective method of deployment. This may be due in part to the use of the antenna's ground plane as the ground for the PIM control circuit, which provides a solid ground for the PIM control circuit.

Nevertheless, other types of PIM control circuits may be advantageous for other types of applications. For example, the PIM control circuit 18′ may alternatively be located on the transmission line side of the junction 15, as shown in FIG. 1B. In this case, the distributed elements of the PIM control circuit 18′ may be constructed from defined length and impedance segments of coaxial cable or other types of transmission media. Alternatively, the PIM control circuit 18′ may be constructed using a microstrip transmission media and distributed elements constructed from microstrip transmission media, and may include coaxial-to-microstrip junctions on either end. This type of “patch-in” board may be located anywhere along the transmission media 14. For example, FIG. 1C illustrates a PIM control circuit 18″ located near the signal generator 12, where a solid ground may also be available, which may make this a convenient alternate location for the PIM control circuit 18″ for some applications. Further, a “patch-in” board containing input and output junctions, such as coaxial-to-microstrip junctions, may include distributed elements constructed from any type of transmission media, since it simply splices in anywhere along the transmission media 14. This type of PIM control circuit may therefore serve as a modular upgrade to any type of existing communication system, without having to modify or splice into the transmission media of the host antenna, signal generator or receiver. Therefore, this may be a preferred approach for upgrading many existing communication systems to include PIM interference control circuits.

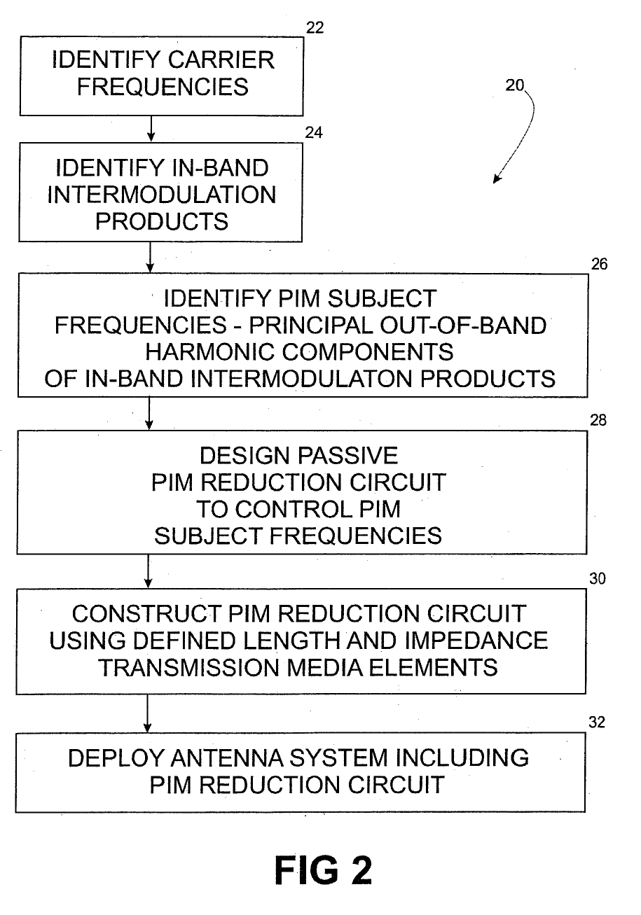

FIG. 2 is a logic flow diagram illustrating a routine 20 for designing and deploying a PIM control circuit to implement an embodiment of the present invention. In step 22, the circuit designer identifies the transmission carrier frequencies for the communication system. From this information, the designer determines the harmonics that will most likely be present in the system, and determines from this the likely intermodulation products. Step 22 is then followed by step 24, in which the circuit designer identifies the in-band intermodulation products. That is, the circuit designer identifies which potential intermodulation products occur at a frequency lying with a reception band of the communication system. Once the in-band intermodulation products have been identified, step 24 is followed by step 26, in which the circuit designer identifies the PIM subject frequencies, which are typically the principal out-of-band harmonic components of the in-band intermodulation products. For example, the PIM subject frequency may often be the second harmonic of one of the carrier frequencies. In particular, the PIM subject frequency 2f₁ typically corresponds to an in-band intermodulation product 2f₁−f₂ and the PIM subject frequency 2f₂ typically corresponds to an in-band intermodulation product 2f₂−f₂, which will often be the most significant intermodulation products when they occur within the reception band of the communications system.

Once the PIM subject frequencies have been identified, step 26 is followed by step 28, in which the circuit designer designs a PIM control circuit to directly control the PIM subject frequency, which indirectly controls the in-band PIM products without attenuating or otherwise distorting the desired in-band signals. As noted previously, the PIM control circuit can be designed to substantially reduce the PIM subject frequency without significantly attenuating or distorting the communication desired in-band signals because the PIM subject frequencies, by definition, occur outside the reception band. In addition, the PIM control circuit may be designed to use absorptive or reflective control techniques, or a combination of these techniques, to effectively suppress the net PIM subject frequency signal propagating back into the signal generator, forward through the antenna, or in both directions. In other words, the PIM control circuit may effect forward, reverse, or bi-lateral suppression of the PIM subject frequencies.

Once the desired PIM control circuit has been designed, step 28 is followed by step 30, in which the circuit designer constructs the PIM control circuit using the desired type of substrate, transmission media, distributed elements, and discrete elements, as desired. In particular, the PIM control circuit will typically include at least one distributed element constructed from a defined length and impedance segment of transmission media, and may also include one or more discrete elements, if desired, such as resistors, capacitors and inductors. In addition, the PIM control circuit may often be, but is not necessarily, directly connected to the transmission media of the subject antenna through a continuous extension of the antenna's transmission media. Of course, the constructed PIM control circuit is typically tested to ensure that it exhibits the desired frequency response.

Once the desired PIM control circuit has been constructed and tested, step 30 is followed by step 32, in which the communication system or antenna including the PIM control circuit is deployed and operated in the usual manner. Because the PIM control circuit is passive by design, it does not include any active elements to fail or require calibration, and it does not require an electric power supply to operate. In addition, many PIM control circuits will not include any adjustable elements. However, the PIM control circuit could be designed to include one or more tunable elements, such as adjustable-length distributed elements. For example, an adjustable-length distributed element may be implemented as, or may be analogous to, a “trombone” type adjustable-length waveguide element. Tunable resistors (e.g., pots), capacitors and inductors may also be incorporated into the PIM control circuit to permit fine-tuning of the circuit in the field. For example, resistive film may be used to construct distributed resistive elements, which may be deployed in fixed-length or adjustable-length configurations.

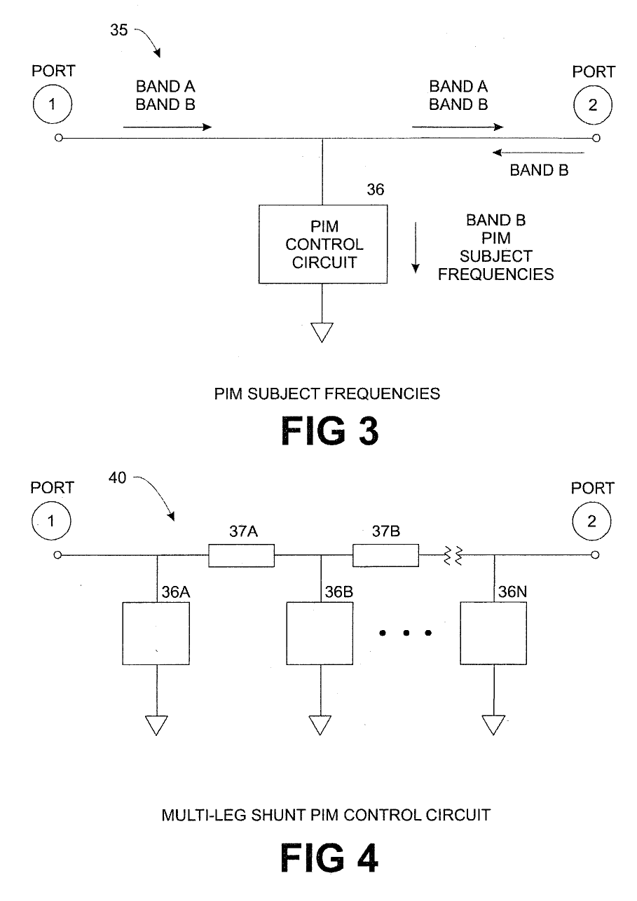

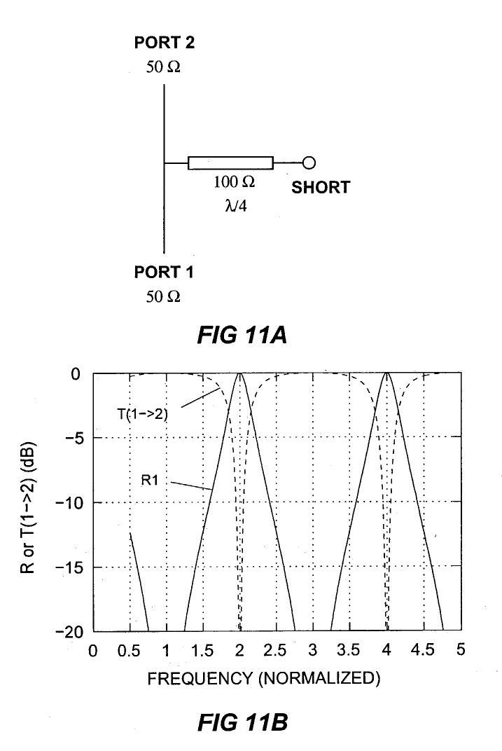

FIGS. 3-8 include functional block diagrams illustrating a number of high-level PIM control circuit configurations, and FIGS. 11A-28A show schematic diagrams of a number of specific example circuit configurations including specific sets of circuit elements connected in particular configurations. FIGS. 11B-28B show the frequency response curves of the corresponding specific PIM control circuits shown in FIGS. FIGS. 11A-28A. In general, each PIM control circuit includes an interconnected combination of elements including at least one distributed element implemented as a defined length and impedance segment of transmission media, in which the width and length of the segment is selected to have a desired impedance and phase characteristic. Typically, several distributed element of this type are interconnected into a circuit configuration, which may also include one or more discrete or “lumped” electrical elements, such as resistors, capacitors and inductors. In particular, resistive elements, which may be discrete resistors or distributed resistive elements in the form of resistive film or blocks, are preferably included in PIM control circuit configurations to partially or completely absorb the PIM subject frequency energy.

In addition, PIM circuits may be designed to implement both absorptive and reflective PIM control techniques. Further, in some low frequency applications, such as applications below about 700 MHz, it may be desirable to construct a PIM control circuit from discrete elements alone (i.e., without distributed elements). However, for most RF applications, it is believed that including one or more distributed elements in the PIM control circuit will improve the performance of the circuit and provide the circuit designer with the ability to accurately design the circuit to have a desired frequency response. This design flexibility results from the ability to accurately control the length and impedance of the distributed element, and in this manner accurately control the phase characteristic of a known a signal having a known wavelength propagating through the distributed element.

FIG. 3 is a functional block diagram of a communication system including a PIM control circuit 35, which includes a shunt PIM control circuit 36 connected between the communication system transmission media and ground. The communication system is represented by two ports, port 1 and port 2, connected by a transmission media that is propagating energy in a forward direction, which is represented as left to right in FIG. 3. The transmission signals occur in two bands, which are designated “band A” and “band B.” In this illustration, band A represents at least two transmission carrier frequencies, which are forward transmission frequencies that the designer wants to propagate without attenuation. Band B represents the PIM subject frequencies, such as the second harmonics of the transmission carrier frequencies, which are frequencies that the designer wants to partially or completely attenuate in the forward and reverse directions without adversely affecting transmission of the desired signals in band A or received signals in a reception band.

FIG. 3 also illustrates the absorptive PIM control technique, which involves shunting a portion of the band B PIM subject frequencies to ground, as illustrated by the arrow pointing down the shunt leg 36. In addition, the reflective PIM control technique is illustrated by the reflected band B component propagating in the reverse direction, which is represented by the arrow labeled “band B” pointing from right to left from port 2 toward port 1. As noted previously, reflective PIM cancellation involves adjusting the amplitude and phase of the reflected, reverse propagating PIM subject frequency signals so that they cancel out or offset the forward propagating PIM subject frequency signals. It is believed that a properly matched shunt PIM control circuit, such as the circuit 36 illustrated in FIG. 3, may be designed to implement either or both of these PIM control techniques.

FIG. 4 is a functional block diagram of a communication system 40 including a multi-leg shunt PIM control circuit illustrated by the shunt PIM control circuits 36A-N. For example, a multi-leg shunt PIM control circuit may be designed with a separate leg for controlling each of several PIM subject frequencies. The communication system 40 also includes in-line distributed elements 37 A-B representing transmission media segments between the shunt PIM control circuits 36A-N. These transmission media segments may be selected to have desired lengths and impedances, such that they may be properly considered to be PIM control elements. At a minimum, the inherent properties of these transmission media segments should be considered in the design of the other elements of the PIM control circuit so that the overall circuit will exhibit the desired frequency response. A desired result of the circuit of FIG. 4, in contrast to that of FIG. 3, is that the circuit of FIG. 4 may be designed to provide a matched input response at both the fundamental and subject harmonic frequencies.

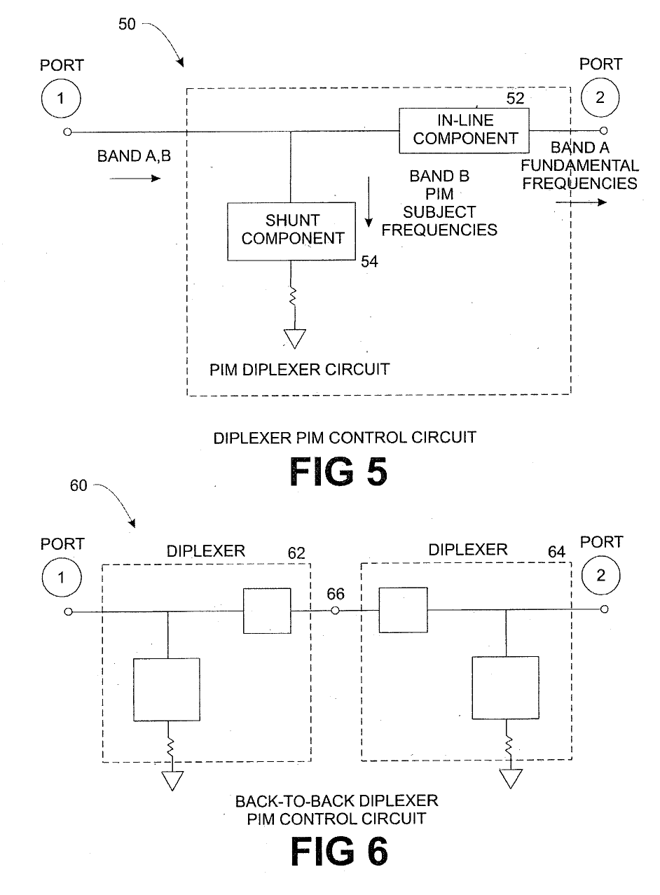

FIG. 5 is a functional block diagram of a communication system including a PIM diplexer control circuit 50, which includes an in-line component 52 and a shunt component 54. In general, it is believed that a properly matched diplexer PIM control circuit, such as the circuit 50 illustrated in FIG. 5, may be designed to effectively absorb a PIM subject frequency to acceptable design standards by directing that frequency component through the shunt leg 54, where it is absorbed by the discrete resistor shown in the shunt leg, and further directed to ground. Nevertheless, it should be understood that the PIM diplexer control circuit 50 may alternatively be designed to implement reflective PIM control, or to implement a combination of absorptive and reflective PIM control.

FIG. 6 is a functional block diagram of a communication system including a back-to-back diplexer PIM control circuit 60, which includes two PIM diplexer control circuits 62 and 64 connected to each other at a node 66. Typically, the PIM diplexer control circuits 62 and 64 are implemented as bi-directionally equivalent mirror images of each other, which provides the PIM control circuit 60 with the same frequency response in the forward and reverse directions. In this manner, the PIM control circuit 60 can be designed to apply PIM control to PIM subject frequencies propagating in the forward and reverse direction. This type of control technique might be advantageous in applications with significant levels of reflected PIM subject frequencies propagating in the reverse direction through the system. However, other types of back-to-back diplexer PIM control circuits may be implemented to accomplish other design objectives.

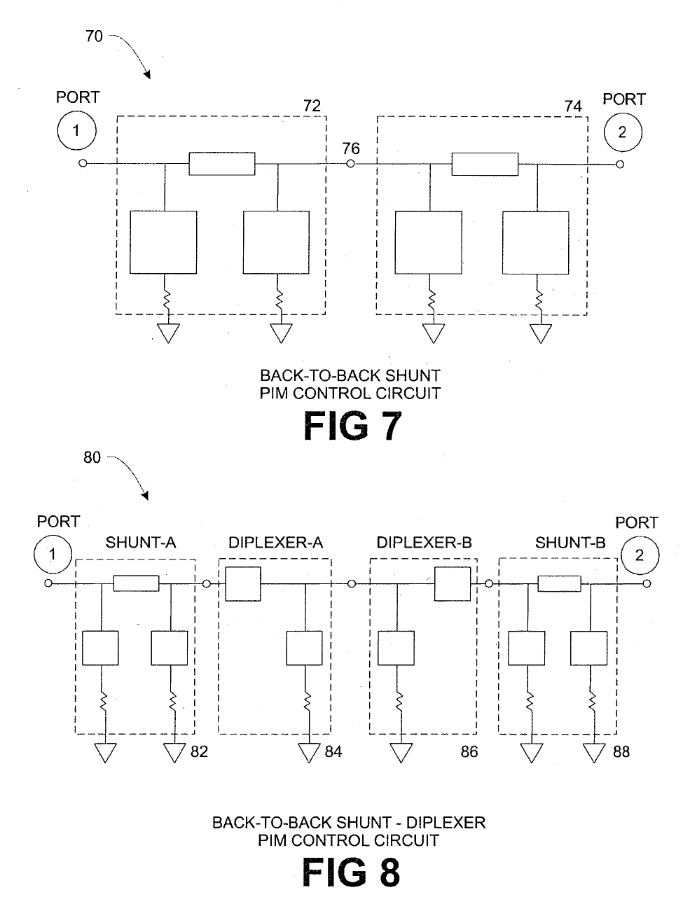

FIG. 7 is a functional block diagram of a communication system including a back-to-back multi-leg shunt PIM control circuit 70, which includes two PIM shunt control circuits 72 and 74 connected to each other at a node 76. Again, the PIM shunt control circuits 72 and 44 are typically implemented as bi-directionally equivalent mirror images of each other, which provides the PIM control circuit 70 with the same frequency response in the forward and reverse directions. In this manner, the PIM control circuit 70 can be designed to apply PIM control for a different PIM subject frequency for corresponding pairs of shunt legs present in the shunt circuits 72 and 74, while also exhibiting the same frequency response in the forward and reverse directions. Again, this type of control technique might be advantageous in applications with significant levels of (in this case multiple) reflected PIM subject frequencies propagating in the reverse direction through the system. However, other types of back-to-back shunt PIM control circuits may be implemented to accomplish other design objectives.

FIG. 8 is a functional block diagram of a communication system including a back-to-back shunt-diplexer PIM control circuit 80, which is included to illustrate the fundamental design technique of combining shunt and diplexer PIM control blocks into more complex circuit configurations. Many other PIM circuit configurations may be designed using the basic design blocks and techniques described above.

FIG. 9A is a perspective view of an antenna 90 including a PIM control circuit 96. The antenna 90 includes a PC board substrate 91 that supports a number of antenna elements (in this case ten) 92A-N mounted above a ground plane 93, which is typically an aluminum tray or back plate that can be solidly connected to electrical ground, such as a building ground, tower ground, or ground spike system. The PC board substrate 91 itself includes a copper ground plane on its bottom surface, which is connected to the ground plane 93 with a two (2) thousands of an (0.002) inch thick layer of dielectric acrylic transfer adhesive, which results in a capacitive ground. This capacitive grounding technique is believed to be an advantageous grounding system for PIM control, as described in U.S. Pat. No. 6,067,053, which is incorporated herein by reference. The antenna elements 92A-N are mounted on the PC board substrate 91, which carries a microstrip transmission media 95 defining a power divider circuit 94 that divides and delivers the high-power transmission signal to the antenna elements 92A-N. Received signals also travel through the power divider circuit 94 in the reverse direction. A coaxial-cable-to-microstrip junction 97 allows the antenna 90 to be connected to a coaxial cable transmission media, and from there to the signal generator or other equipment associated with the communication system.

The PIM control circuit 96 is formed on a piece of PC board similar to the PC board 91, and is also mounted on the ground plane 93 using the technique described above. That is, in this particular example, the PIM control circuit 96 is physically constructed on a separate daughter PC board that is mounted next to the antenna's PC board 91 on, and supported by, the antenna's ground plane 93. However, the PIM control circuit 96 could have alternatively been formed on the same PC board 91 as the antenna 90. In addition, the PIM control circuit 96 is directly connected to the antenna's microstrip transmission media 95 through a continuous extension of the antenna's microstrip transmission media.

FIG. 9B is an exploded perspective view of the central portion of the antenna array 90, which shows the PIM control circuit 96 and certain elements of the antenna array 90 in greater detail. In particular, each antenna element, as represented by the antenna element 92, includes two separate vanes 92′ and 92″, which together form a dual polarized dipole antenna element. A “set” of polar vanes is comprised of vanes with like orientations relative to the antenna array axis. Each set of polar vanes are fed by a separate power divider, with the power divider 94A feeding the polar vanes 92′ of antenna elements 92A-N, and the power divider 94B feeding the polar vanes 92″ of antenna elements 92A-N. For this reason, the antenna array 90 includes two PIM control circuits, represented by the PIM circuit 96, i.e., one for each set of polar vanes, as represented by the polar vanes 92′ and 92″ shown in FIG. 9B. Both PIM control circuits are shown in FIG. 9A, whereas the separate polar vanes 92′ and 92″, and the separate power dividers 94A and 94B, are shown best in FIG. 9B.

FIG. 9B also shows the coaxial-to-microstrip junction 97 in greater detail, which includes a conductive jacket 102 mounted to the bottom of the ground plane 93. The conductive jacket 102 electrically connects the outer shield of the coaxial cable to the ground plane 93, whereas the center conductor 101 of the coaxial cable is typically soldered to the microstrip connection pad 103. This microstrip connection pad, in turn, feeds the microstrip transmission media of the PIM control circuit 96, which includes microstrip transmission media links and distributed elements connected into a desired circuit configuration. These distributed elements, as represented by the distributed element 99, are preferably implemented as defined length segments of microstrip transmission media. As discussed previously, the lengths and widths of these distributed elements are selected to exhibit desired impedance and phase characteristics, which allows the PIM control circuit 96 to have a desired frequency response determined by the circuit designer. The PIM control circuit 96 also includes discrete elements, represented by the discrete resistive element 98, which is implemented as a conventional resistor.

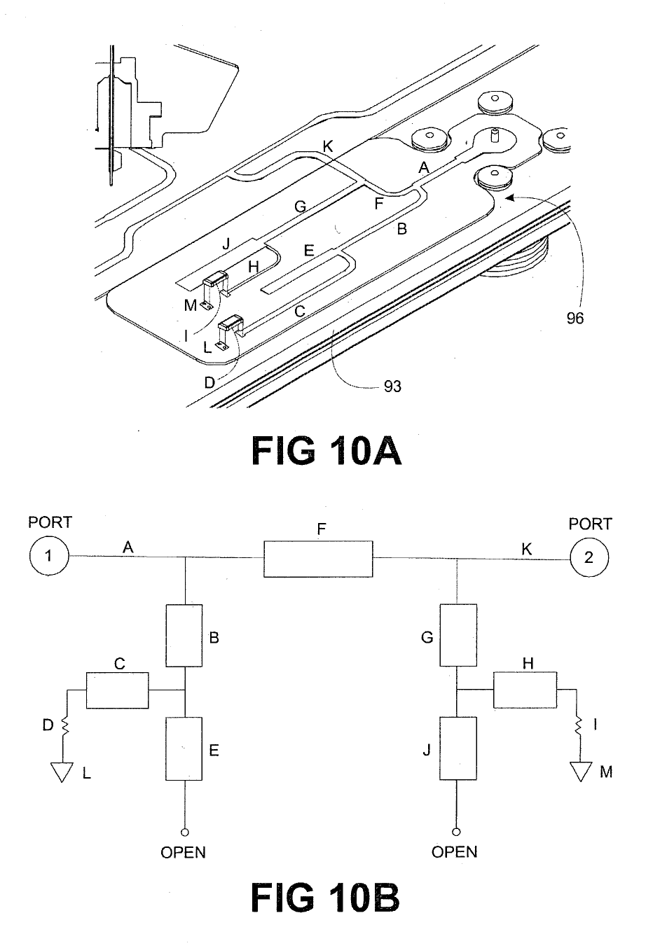

FIG. 10A is a perspective view of the PIM control circuit 16 including reference letters identifying physical components of the circuit. FIG. 10B is a schematic diagram of the same PIM control circuit shown in FIG. 10A including like reference letters identifying the schematic symbols corresponding to the physical components of the circuit. As shown, the input port of the PIM control circuit 16 corresponds generally to the solder pad 103, which is connected to the remainder of the PIM circuit by an extension of microstrip transmission line A, which is also indicated on FIG. 10B. This extension branches into two parallel legs, which are separated by an extension of microstrip transmission line F, which has an electrical impedance represented by the box labeled “F” in FIG. 10B. The first parallel branch includes an extension of microstrip transmission line B, which has an electrical impedance represented by the box labeled “B” in FIG. 10B. Element B is then connected to a distributed element E, which is constructed from a segment of microstrip transmission media having a length and width selected to have a desired impedance and phase characteristic. This element is represented by the box labeled “E” in FIG. 10B. Beyond element E, this leg terminates in an open circuit. In addition, a branch of microstrip transmission media C extends from the junction between elements E and B to a discrete resistive element D. The impedance of the branch of microstrip transmission media C is represented by the box labeled “C” in FIG. 10B, and the resistor D is represented by a resistor traditional symbol labeled “D” on FIG. 10B. The resistor D is connected to the ground plane 93 by a plated-thru connection L.

The second parallel branch is located across the extension of the microstrip transmission media segment F from the first parallel branch, and includes a segment of microstrip transmission media G, which has an electrical impedance represented by the box labeled “G” in FIG. 10B. Element G is then connected to a distributed element J, which is constructed from a segment of microstrip transmission media having a length and width selected to have a desired impedance and phase characteristic. This element is represented by the box labeled “J” in FIG. 10B. Beyond element J, this leg terminates in an open circuit. In addition, a branch of microstrip transmission media H extends from the junction between elements G and J to a discrete resistive element I. The impedance of the branch of microstrip transmission media H is represented by the box labeled “H” in FIG. 10B, and the resistor I is represented by a resistor traditional symbol labeled “I” on FIG. 10B. The resistor I is connected to the ground plane 93 by a plated-thru connection M.

FIGS. 10A and 10B illustrate the basic process of representing a physical PIM control circuit in schematic format. This same process has been applied to a number of example PIM control circuits shown in FIGS. 11A-28A, which are only shown schematically. In addition, FIGS. 11B-28B show the frequency response curves of the circuits shown in FIGS. 11A-28A, respectively. The nomenclature shown on these figures is used consistently, and can therefore be explained with reference to one figure and need not be repeated for each figure

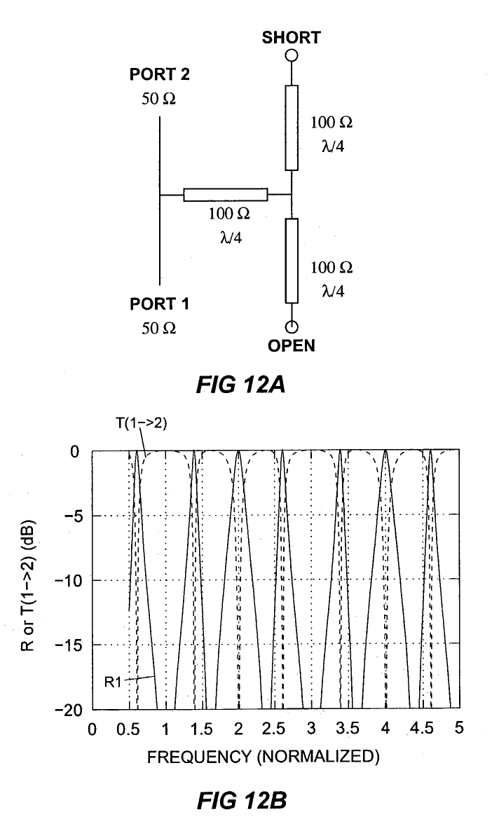

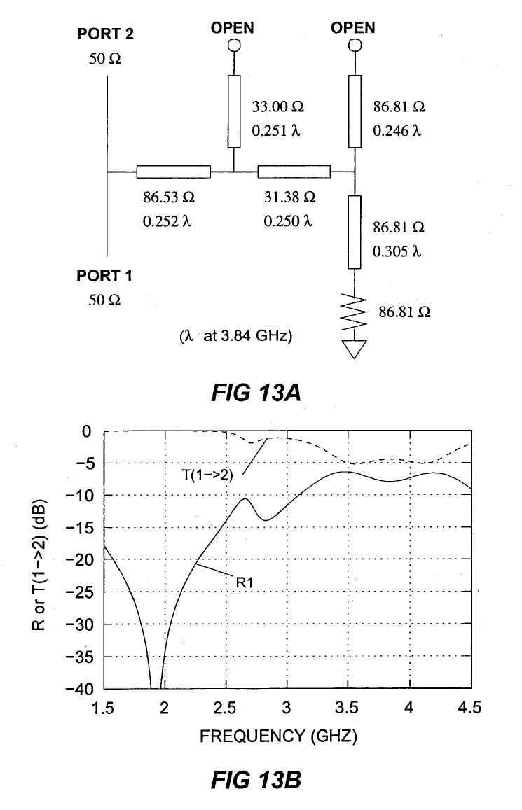

The circuits in FIGS. 11 and 12 are provided to illustrate a few principles of shunt circuits having one or more distributed elements terminated by short circuits or open circuits. The exemplary PIM control circuits FIGS. 13-28 are designed to control a third order intermodulation product by controlling a second (2^{nd}) order harmonic of an operational band. In other words, the PIM subject frequencies in the examples in FIGS. 13-28 are the second (2^{nd}) harmonic of an operational band of frequencies having a first lower frequency limit and a first upper frequency limit. The operational band is also called the “fundamental frequency band” in FIGS. 13-28. The PIM subject frequencies have a band of frequencies with a second lower frequency limit and a second upper frequency limit. The second lower frequency limit is twice, or two times, the first lower frequency limit and the second upper frequency limit is twice, or two times, the first upper frequency limit. The PIM subject frequencies defined by a second lower frequency and a second upper frequency are also, called the “second (2^{nd}) harmonic frequency band” in these exemplary examples shown in FIGS. 13-28. In FIGS. 13-28, the first lower frequency limit is 1.850 GHz and the first upper frequency limit is 1.990 GHz corresponding to the full operational band of the US PCS licensed frequency spectrum. The second lower frequency limit is 3.70 GHz and the second upper frequency limit is 3.98 GHz. The center frequency of the operational or fundamental band is 1.92 GHz and the center frequency of the second (2^{nd}) harmonic frequency band is 3.84 GHz.

The exemplary circuits in FIGS. 13A-28A are designed for a primary transmission line media having a characteristic impedance of fifty Ohms (50 Ω). A person of ordinary skill in the art will appreciate that these and other exemplary PIM control circuits having similar performance attributes and properties can be designed for primary transmission lines having other characteristic impedance values. Further, it will also be understood that exemplary PIM control circuits having similar performance attributes and properties can be designed for primary transmission lines that have different characteristic impedance values associated with ports 1 and 2, respectively.

Referring to FIG. 11A as a first example of the nomenclature used in FIGS. 11-28, the rectangular block represents a distributed element of transmission media. In this instance, the block is labeled “100 Ω” to indicate that the transmission media has been selected to have characteristic impedance of 100 Ohms (Ω). In addition, the air equivalent length of this element is indicated as λ/4, where λ represents the wavelength corresponding to the center frequency of the operational or fundamental frequency band. In the particular examples shown in FIGS. 11A-28A, this wavelength A shown in connection with the discrete element shown in FIG. 11A corresponds to the frequency value of 1.92 GHz.

As shown, the circuit in this example is a 100 Ω distributed element with an air equivalent length of λ/4 at 1.92 GHz. This element, which is preferably connected directly to the transmission media connecting port 1 to port 2 by a continuous extension of the same type of transmission media, is connected in a shunt configuration. This shunt connected distributed element is configured with a “short circuit” condition terminating at the end of the element away from the connection point. The short circuit condition implies there is ideally a reflection coefficient of plus one (−1) at the end of the transmission media to a RF signal propagating on the transmission line and propagating away from the main transmission media connecting port 1 and port 2. An open circuit condition at an end of a transmission media implies there is ideally a reflection coefficient of plus one (+1) at the end of the transmission media.

A person of ordinary skill in the art will recognize that the air equivalent length can be converted to a particular transmission media having a characteristic signal propagation velocity. A particular transmission media that has a property of being characteristically a transverse electromagnetic (TEM) or quasi-TEM fundamental mode of signal propagation has a wavelength that can be directly related to the air equivalent wavelength with a linear relationship through a parameter known as an effective dielectric constant. A particular transmission media that has media that has dispersive propagation characteristics can also be related to the air equivalent wavelength at a particular frequency value through the use of more involved non-linear relationships.

FIG. 11B is a graph illustrating the frequency response of the circuit shown schematically in FIG. 11A. The vertical axis represent a signal parameter magnitude expressed in decibels (dB), and the horizontal axis represents normalized frequency with reference to the center of the operational frequency band, in this example 1.92 GHz, which is the center of the licensed US PCS band, as noted above. The graph labeled “R1” represents the voltage return loss value at port 1, and the graph labeled “T1->2” represents the voltage transmission value from port 1 to port 2. Thus, FIG. 11B shows that the circuit shown in FIG. 11A is “impedance matched” at the fundamental frequency in that the transmission value from port 1 to port 2 (T1->2) is zero (0) dB at the fundamental frequency (i.e., “0” on the vertical axis and “1” on the horizontal axis). This is also represented by a very low return loss value at the fundamental frequency, indicating that virtually none of the fundamental frequency is reflected from port 1. This frequency response also repeats for the third, fifth and higher odd harmonics.

Further, FIG. 11B shows that the circuit shown in FIG. 11A effectively blocks transmission of the second harmonic of the fundamental frequency in that the transmission value from port 1 to port 2 (T1->2) is very low at the second harmonic (i.e., “−20 dB on the vertical axis and “2” on the horizontal axis). This is also represented by a zero (0) dB return loss value at the second harmonic frequency, indicating that virtually all of a signal at the second frequency is reflected from port 1. This frequency response also repeats for the fourth and higher even harmonics. In other words, the frequency response curve repeats at frequency intervals of a factor two (2) increments of the fundamental frequency. Each band of frequencies that has relatively low return loss value while having relatively high transmission characteristics and as such is commonly called a “pass band” of frequencies. . Note that this circuit does not absorb any of the input energy because it does include any resistive elements. Therefore, virtually all of the input energy is either transmitted or reflected by the circuit.

FIG. 12A is a schematic diagram of a second exemplary circuit, in this case a “T” circuit, which again does not include any resistive elements. This circuit has one distributed element terminated in an open circuit and one distributed element terminated in a short circuit. These two distributed elements are connected to the primary transmission line through a third distributed element. This circuit has a frequency response that is similar to the frequency response of the circuit of FIG. 11A, having pass bands at odd multiples of the fundamental frequency. However, the circuit of FIG. 12A has a pair of pass band frequencies near the even order harmonics of the fundamental frequency. The pass band frequency pair occur slightly below and above the even order harmonics.

FIGS. 11A and 12A illustrate that a circuit configured as a shunt connection to a primary transmission line can be designed to produce signal reflection and transmission properties relative to an input port and an output port of the primary transmission line where independent control of the fundamental in-band performance and the out-of-band performance of one or more harmonics of integer or fractional order relative to the fundamental can be achieved. In other words, a primary transmission line can have a shunt circuit configured to produce the transmission properties of a pass band in a particular operational band while having one or more pass and or rejection bands occurring at predetermined frequencies outside the operational band. The circuit can be constructed from one or more distributed elements formed from defined-length segments of transmission line media, each having a characteristic impedance value, and one or more transmission lines can be terminated in a short circuit or an open circuit.

Although the circuits in FIGS. 11A and 12A would not function as effective PIM control circuits because they do not include any resistive elements to control the amplitude or power at the PIM subject frequencies or second harmonic frequencies, they are capable of controlling the reflected and transmission of a signal amplitude or power of a PIM subject frequency by reflection principles of a portion or all of the subject signal amplitude. They also illustrate the design technique controlling the transmission and reflection properties of communication system at a range of frequencies through the use of defined-length segments of transmission media having selected impedance values.

FIG. 13A is a schematic diagram of a third exemplary PIM control circuit, which in this case includes a modified shunt “pi” configured circuit including a resistive element of 81.81 Ω connected to ground. The presence of this resistive element absorbs some of the input energy, and therefore results in a frequency response curve that does not repeat for multiples of the fundamental frequency. In this exemplary embodiment, the circuit has five (5) distributed elements. Two distributed elements are terminated in open circuits and a third element is terminated in a resistive element that can be a lumped element resistor or a distributed element resistor. This exemplary circuit is comprised of distributed elements having characteristic impedance and effective wavelength -equivalent length values defined for a wavelength corresponding to the center frequency of a second harmonic band. As shown in FIG. 13B, this circuit transmits the fundamental band largely without attenuation, but attenuates higher frequencies to a moderate degree.

FIG. 13B is a graph illustrating the frequency response of the PIM control circuit shown schematically in FIG. 13A. This particular exemplary circuit provides a pass band at the fundamental or operating band and has characteristics of a transmission value of approximately minus five (−5) dB and return loss value of approximately minus seven (−7) dB in the second harmonic band. Hence, the single shunt connected exemplary circuit in FIG. 13A provides a partial impedance match at the second harmonic band and a portion of the second harmonic signal amplitude is dissipated or absorbed in a resistive element.

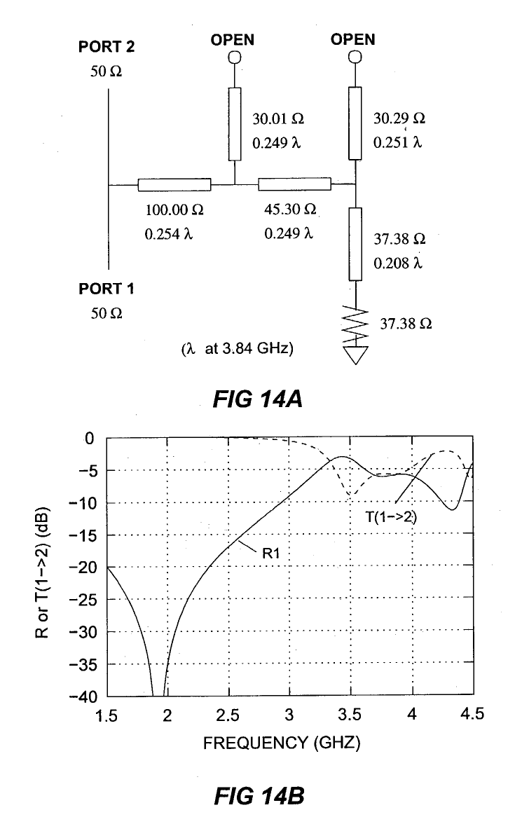

FIG. 14A is a schematic diagram of a fourth exemplary PIM control circuit. This exemplary circuit topology is identical to the circuit in FIG. 13A. However, the characteristic impedance values and element lengths are different as a result of the design criteria being equalizing the “R” and “T” values in the second harmonic frequency band as shown in the frequency response curves FIG. 14B. The circuits of FIGS. 13A and 14A have a pass band in the fundamental or operational band with a high transmission value and a low return loss value. Effectively, the circuit has little or no effect on the primary transmission line in the fundamental or operational band. The effect at the second harmonic frequency band is to present a shunt resistance to the primary line. The net effect is forty-four percent (44%) and forty-eight percent (48%) absorption of the second harmonic signal power in the exemplary circuits in FIGS. 13A and 14A, respectively. Both exemplary circuits in FIGS. 13A and 14A are the single shunt type depicted in FIG. 3.

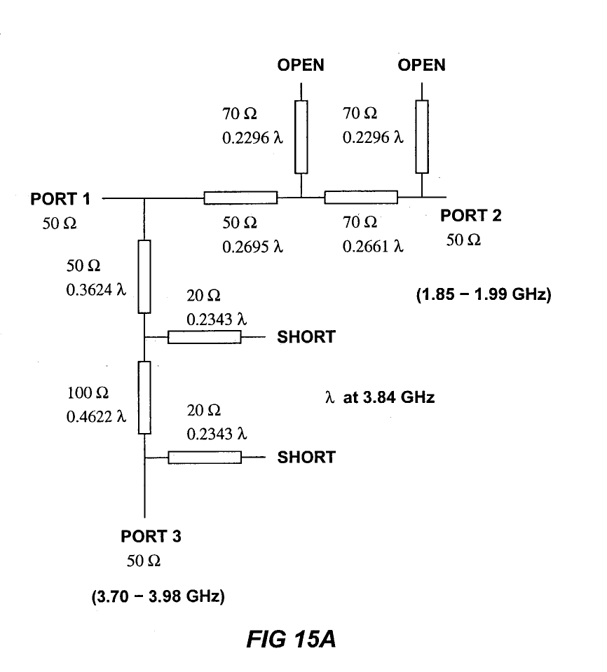

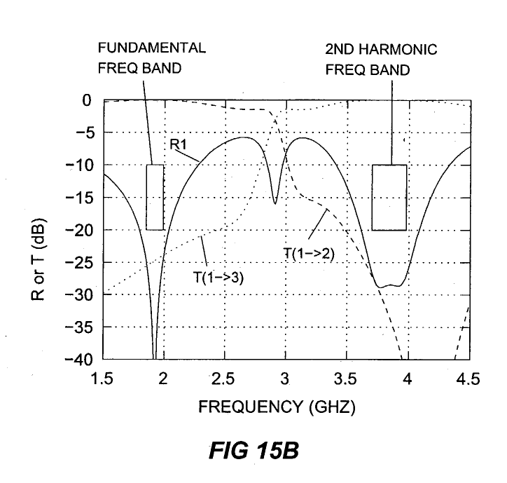

FIG. 15A is a schematic diagram of a fifth exemplary PIM control circuit. FIG. 15A is a single diplexer type PIM control circuit functionally depicted in FIG. 5. The exemplary circuit in FIG. 15A is designed to provide a pass band for the fundamental or operation band between ports 1 and 2 while providing a pass band for the second harmonic band between ports 1 and 3. This particular exemplary circuit in FIG. 15A is designed with the theoretic objective of ideally separating and isolating the transmission of the fundamental and second harmonic frequency bands that can coexist at port 1 into separate bands at ports 2 and 3, respectively. This particular control circuit uses open circuit terminations in an in-line circuit portion and short circuit terminations in a shunt circuit portion of the overall circuit.

FIG. 15B is a graph illustrating the frequency response of the PIM control circuit shown schematically in FIG. 15A along with the intended fundamental and second harmonic frequency bands for the circuit. This exemplary circuit has the property that the input is impedance matched at both the fundament and second harmonic frequency bands. The intended use in the application for PIM control is to include a resistive element connected at port 3 that can absorb all or a portion of the signal amplitude or power occurring in the second harmonic band at port 1. A resistive element having a fifty ohm (50 Ω) value can absorb substantially all of the signal amplitude or power in the second harmonic band whereas a value other than fifty (50) Ohms will not be matched to the present circuit and will therefore reflect a portion of the second harmonic signal amplitude or power.

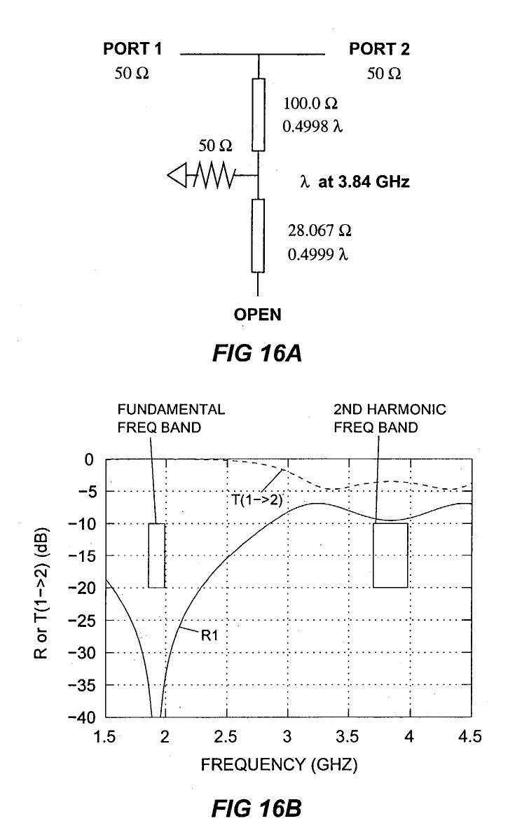

FIG. 16A is a schematic diagram of a sixth exemplary PIM control circuit. FIG. 16A is a single shunt type PIM control circuit functionally depicted in FIG. 3. The exemplary circuit is comprised of two distributed elements and one resistive element. One of the distributed elements is terminated with an open circuit. Both of the distributed elements has a length of approximately one-half (0.50) wavelength (λ) at the second harmonic frequency that is 3.84 GHz and the length corresponds to approximately one-quarter (0.25) wavelength at the fundamental frequency, which is 1.92 GHz. The two distributed elements have different characteristic impedance values, one being one hundred Ohms (100 Ω) and the other being approximately twenty-eight Ohms (28 Ω)).

FIG. 16B is a graph illustrating the frequency response of the PIM control circuit shown schematically in FIG. 16A along with the intended fundamental and second harmonic frequency bands for the circuit. Basically, this exemplary circuit will result in a high impedance shunt at the operation frequency band and a shunt load at the second harmonic frequency band. For a shunt fifty Ohms (50 Ω) load, the associated voltage reflection coefficient on the main is 0.3333 (−9.54 dB) and a voltage transmission coefficient value of 0.6667 (i.e., 1+R or −3.54 dB). These values occur at the second harmonic design value of 3.84 GHz.

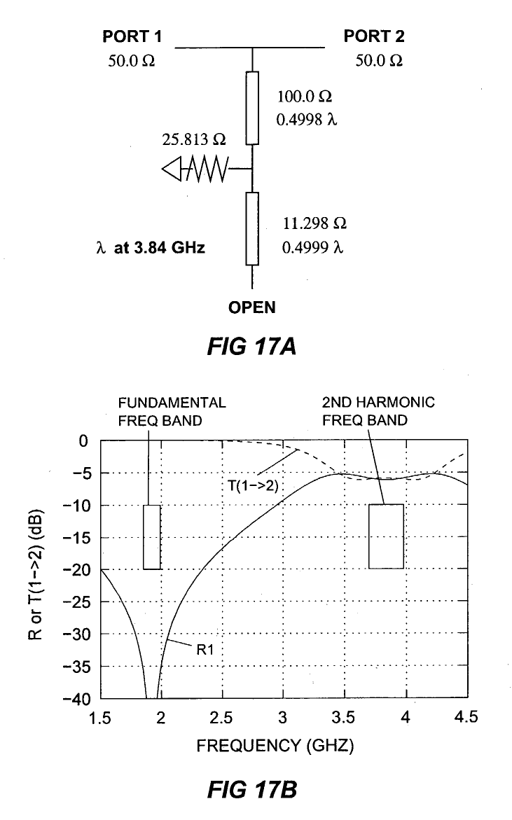

FIG. 17A is a schematic diagram of a seventh exemplary PIM control circuit. FIG. 17A is a single shunt type PIM control circuit functionally depicted in FIG. 3. This particular circuit has been designed to achieve the theoretic objective of maximizing the absorption of the PIM energy at the second harmonic.

FIG. 17B is a graph illustrating the frequency response of the PIM control circuit shown schematically in FIG. 17A as long with the intended fundamental and second harmonic frequency bands for the circuit. From radar absorbing material-theory, it is well known that a shunt resistive load will result in maximal power absorption whenever the normalized resistance is one-half (0.5) (or twenty-five Ohms (25 Ω) in the present circuit, which has a primary transmission line impedance of fifty Ohms (50 Ω)). The resulting return loss and transmission value will both be −6.02 dB. In this exemplary circuit, fifty percent (50%) of the second harmonic signal power will be absorbed in the resistive element in comparison to the exemplary circuits in FIGS. 13A and 14A, where less than fifty percent (<50%) of the second harmonic signal power was absorbed in the resistive element.

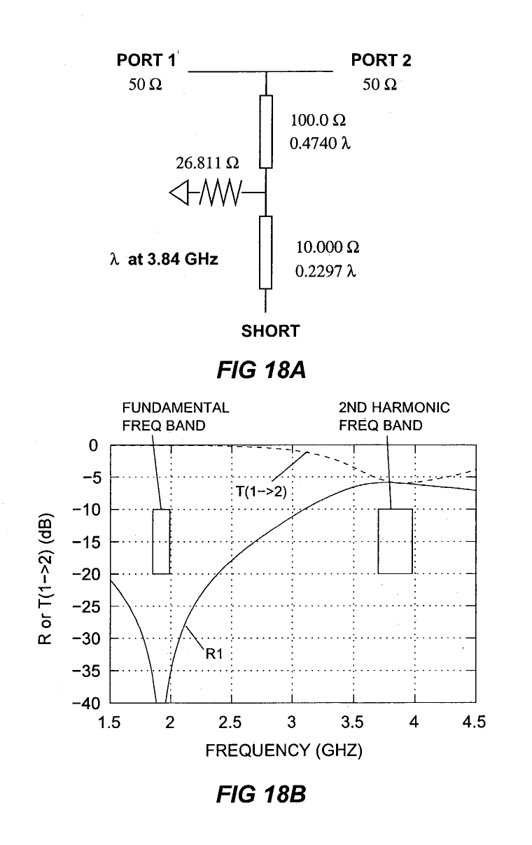

FIG. 18A is a schematic diagram of an eighth exemplary PIM control circuit. FIG. 18A is a single shunt type PIM control circuit functionally depicted in FIG. 3. FIG. 18A is distinguished from the circuit topology in FIG. 17A by the use of a short circuit termination of a distributed element in place of the open circuit termination used in the exemplary circuit in FIG. 17A. The circuit element values are substantially the same as in FIG. 17A except for the element terminated by the short. The element terminated by the short circuit in FIG. 18A has a different impedance value and different length than the element terminated by the open circuit in FIG. 17A. A person of ordinary skill in the art will recognize that the use of short circuit terminations or open circuit terminations can be used in these exemplary circuit topologies and through appropriate adjustment of the relevant circuit element parameters and values the same or similar performance objectives can be achieved in practice.

FIG. 18B is a graph illustrating the frequency response of the PIM control circuit shown schematically in FIG. 18A along with the intended fundamental and second harmonic frequency bands for the circuit. The performance characteristics in the fundamental or operational frequency band and in the second harmonic frequency band are substantially the same as the graph in FIG. 17B. It can be seen that the bandwidth at the second harmonic is somewhat reduced compared to the result in FIG. 17B. Nevertheless, both the reflection and transmission coefficients are observed to be approximately −6.02 dB at 3.84 GHz as expected.

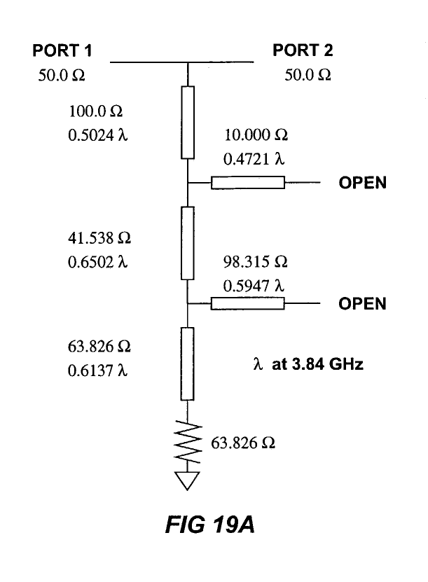

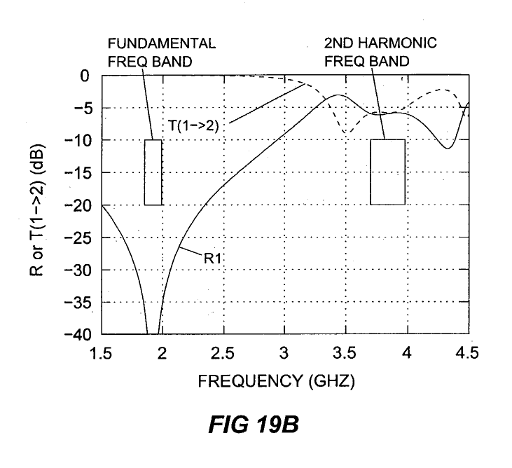

FIG. 19A is a schematic diagram of a ninth exemplary PIM control circuit. FIG. 19A is a single shunt type PIM control circuit functionally depicted in FIG. 3. This particular embodiment has the same circuit topology as FIGS. 13A and 14A.

FIG. 19B is a graph illustrating the frequency response of the PIM control circuit shown schematically in FIG. 19A along with the intended fundamental and second harmonic frequency bands for the circuit. This particular exemplary circuit has been designed with the theoretic objective of optimizing both reflection and transmission coefficients of approximately −6.02 dB at 3.84 GHz to achieve another single shunt PIM control circuit with theoretically maximal power absorption at the second harmonic frequency band.

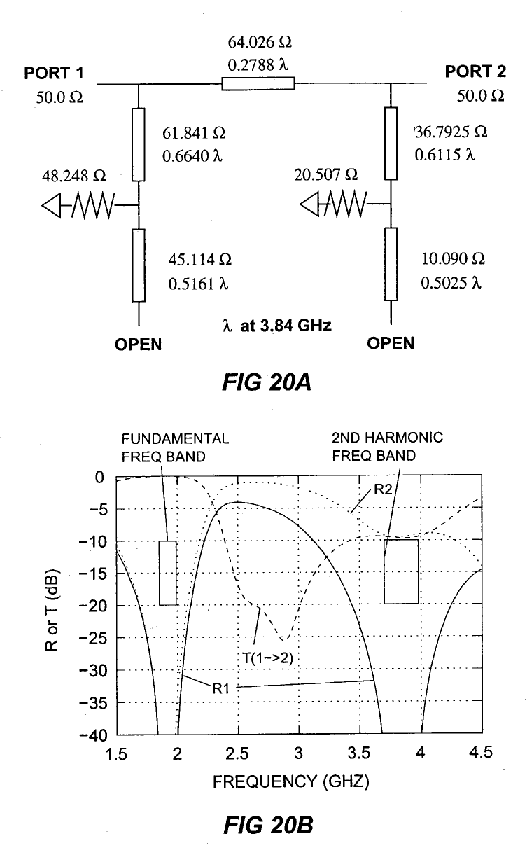

FIG. 20A is a schematic diagram of a tenth exemplary PIM control circuit. FIG. 20A is a double shunt type PIM control circuit functionally depicted in FIG. 4 and can be called alternatively an in-line “pi” type circuit having two shunt legs. This circuit topology represents a next level of complexity for the shunt resistive PIM control circuit by adding a second shunt circuit. In general, two shunt resistances separated by a one-quarter (0.25) wavelength is theoretically capable of a perfect match on the primary transmission line at the PIM subject frequency band. The circuit must be non-symmetrical in order to produce a matched response. The non-symmetrical circuit does not have a reciprocal impedance match. In other words, the impedance match in the forward propagating direction at port 1 is not the same as the impedance match in reverse propagating direction at port 2. This particular circuit is designed for a −10 dB transmission value in the second harmonic frequency band. This circuit is distinguished from the circuits having a single shunt connection by offering an improved impedance match at the second harmonic frequency band at port 1 and increased absorption in the transmission value. FIG. 20B is a graph illustrating the frequency response of the PIM control circuit shown schematically in FIG. 20A along with the intended fundamental and second harmonic frequency bands for the circuit.

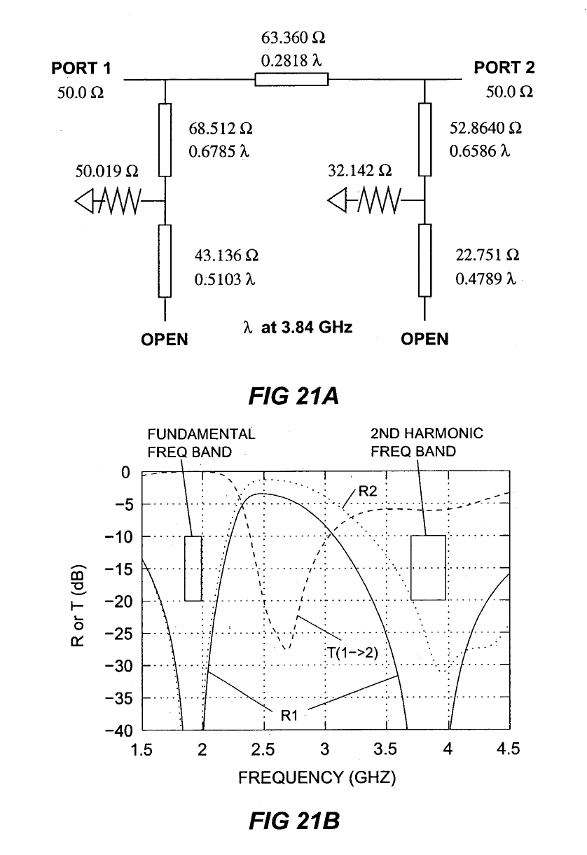

FIG. 21A is a schematic diagram of an eleventh exemplary PIM control circuit. FIG. 21A is a double shunt type PIM control circuit functionally depicted in FIG. 4. This exemplary circuit is designed for a −6 dB transmission value in the second harmonic frequency band.

FIG. 21B is a graph illustrating the frequency response of the PIM control circuit shown schematically in FIG. 21A along with the intended fundamental and second harmonic frequency bands for the circuit.

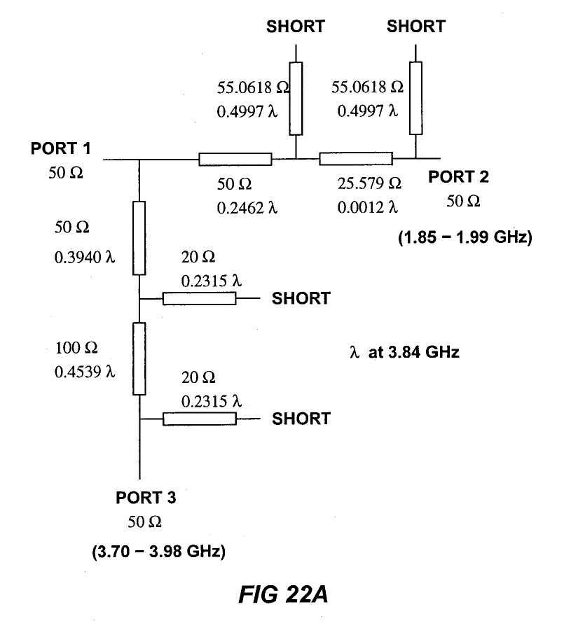

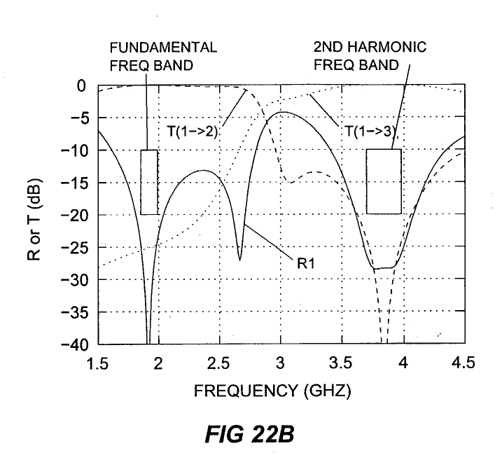

FIG. 22A is a schematic diagram of a twelfth exemplary PIM control circuit. FIG. 22A is a single diplexer type PIM control circuit functionally depicted in FIG. 5. The circuit topology of this particular exemplary circuit is the same as FIG. 15A except the present circuit uses all short circuit terminations whereas the circuit in FIG. 15A uses both open and short circuit terminations. Note that the transmission line separation on the in-line filter is practically zero length and results in a bilateral shorted stub. The impedance values in this circuit are all quite reasonable on the main line. For this circuit and the circuit in FIG. 15A, the impedance values of the input split have been held at 50 Ohms (50 Ω). Further, the in-line and shunt filters have been designed to be symmetric within the respective “pi” circuits by having the distributed elements that are terminated into shorts having equal impedance values and equal lengths.

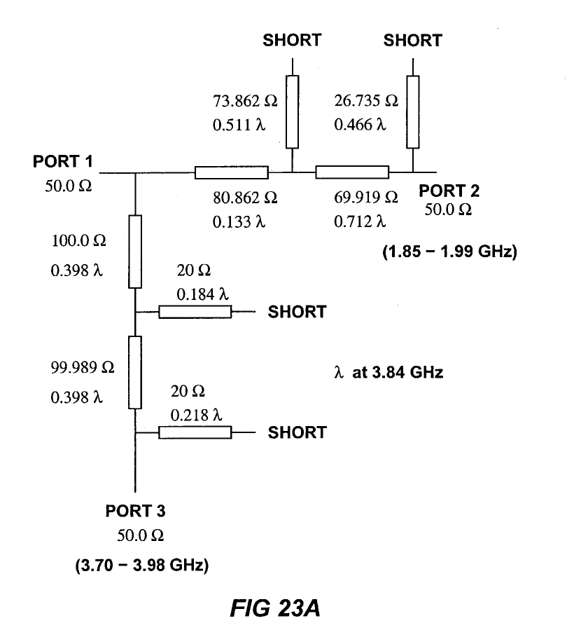

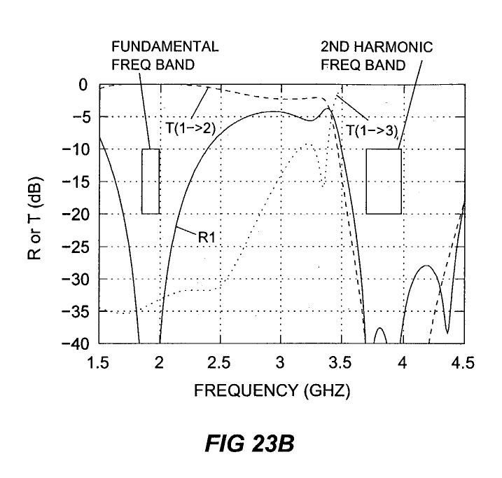

FIG. 22B is a graph illustrating the frequency response of the PIM control circuit shown schematically in FIG. 22A along with the intended fundamental and second harmonic frequency bands for the circuit. FIG. 23A is a schematic diagram of a thirteenth exemplary PIM control circuit. FIG. 23A is a single diplexer type PIM control circuit functionally depicted in FIG. 5. The circuit topology of this particular exemplary circuit is the same as FIG. 22A and likewise has all short circuit terminations. The circuit has is not designed to be symmetric.

FIG. 23B is a graph illustrating the frequency response of the PIM control circuit shown schematically in FIG. 23A along with the intended fundamental and second harmonic frequency bands for the circuit.

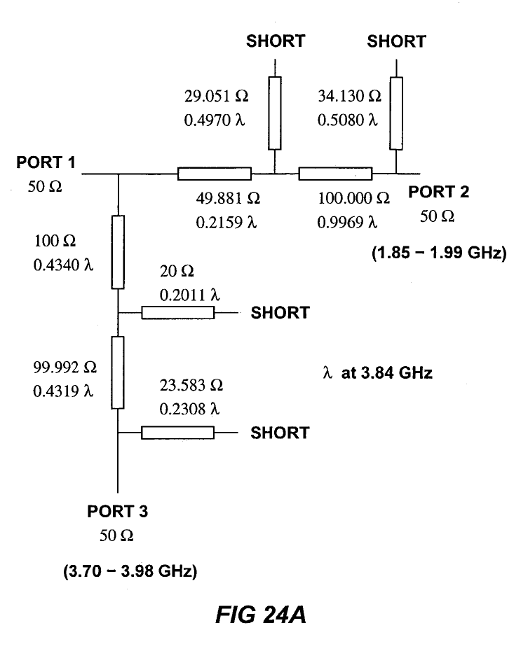

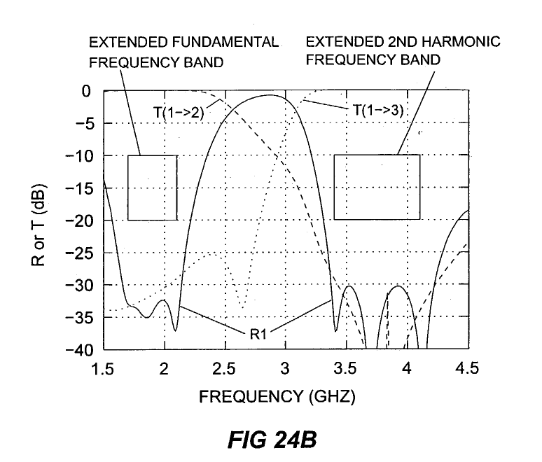

FIG. 24A is a schematic diagram of a fourteenth exemplary PIM control circuit. FIG. 24A is a single diplexer type PIM control circuit functionally depicted in FIG. 5. The circuit topology of this particular exemplary circuit is the same as FIG. 22A and likewise has all short circuit terminations. The circuit has no assumed symmetries and is differentiated relative to FIG. 23A by it being theoretically optimized for an extended fundamental or operating band of 1.7-2.1 GHz.

FIG. 24B is a graph illustrating the frequency response of the PIM control circuit shown schematically in FIG. 24A along with the intended fundamental and second harmonic frequency bands for the circuit. The circuit performance is superior to the preceding single diplexer type PIM control circuits. However, the in-line filter has an impedance value of one hundred Ohms (100 Ω) that is larger than desired for most practical implementations using microstrip transmission line media for the distributed elements. The circuit can be re-designed with different constraints to achieve a solution with similar performance and more desirable impedance values for all the elements.

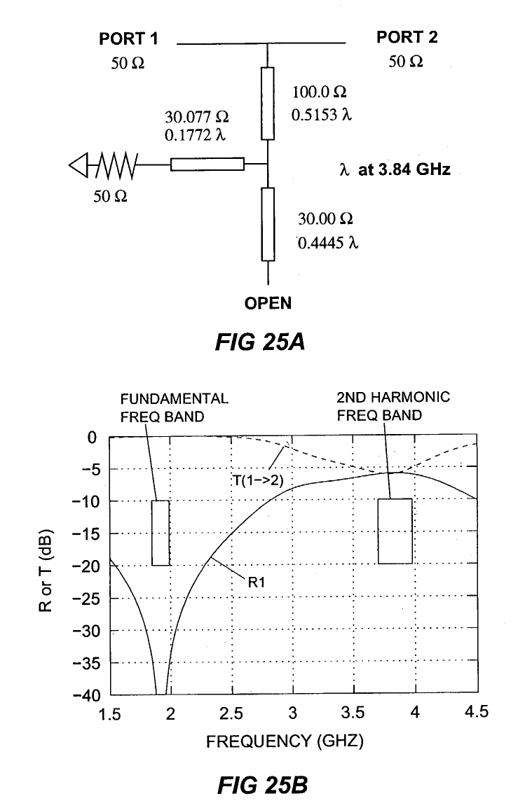

FIG. 25A is a schematic diagram of a fifteenth exemplary PIM control circuit. FIG. 25A is a single shunt type PIM control circuit functionally depicted in FIG. 3.

FIG. 25B is a graph illustrating the frequency response of the PIM control circuit shown schematically in FIG. 25A along with the intended fundamental and second harmonic frequency bands for the circuit.

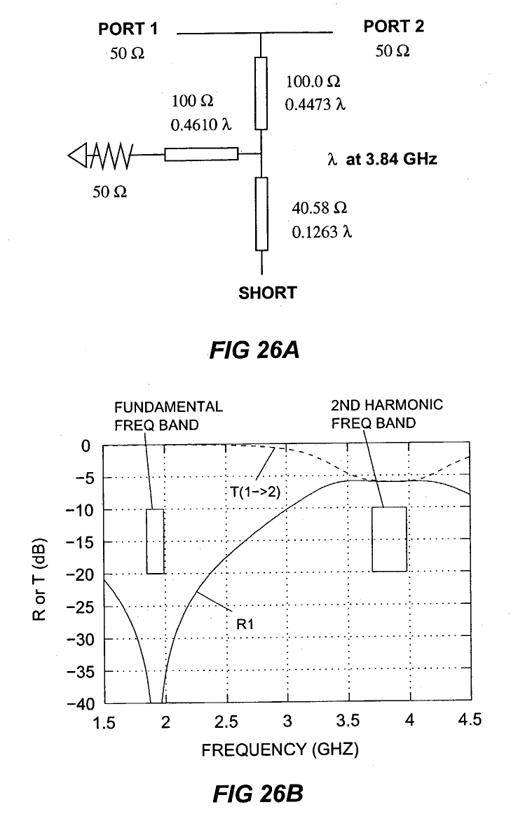

FIG. 26A is a schematic diagram of a sixteenth exemplary PIM control circuit. FIG. 26A is a single shunt type PIM control circuit functionally depicted in FIG. 3.

FIG. 26B is a graph illustrating the frequency response of the PIM control circuit shown schematically in FIG. 26A along with the intended fundamental and second harmonic frequency bands for the circuit. Both of the circuits in FIGS. 25A and 26A have theoretically maximal absorption of the second (2^{nd}) harmonic and present a −6 dB return loss value and transmission value in the second (2^{nd}) harmonic frequency band. The circuit in FIG. 25A has an open circuit termination to a distributed element whereas the circuit in FIG. 26A has a short circuit termination to a distributed element.

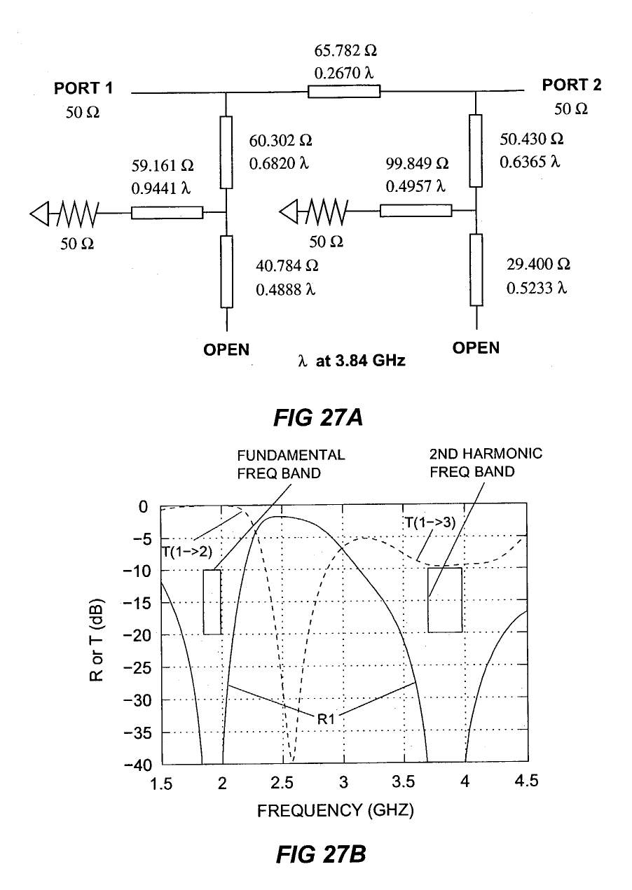

FIG. 27A is a schematic diagram of a seventeenth exemplary PIM control circuit. FIG. 27A is a double shunt type PIM control circuit functionally depicted in FIG. 3. This particular exemplary circuit has been implemented in a microstrip transmission line media for use in an antenna as shown in FIGS. 9A-B and 10A-B. distributed element whereas the circuit in FIG. 26A has a short circuit termination to a distributed element.

FIG. 27A is a schematic diagram of a seventeenth exemplary PIM control circuit. FIG. 27A is a double shunt type PIM control circuit functionally depicted in FIG. 3. This particular exemplary circuit has been implemented in a microstrip transmission line media for use in an antenna as shown in FIGS. 9A-B and 10A-B.

FIG. 27B is a graph illustrating the frequency response of the PIM control circuit shown schematically in FIG. 27A along with the intended fundamental and second harmonic frequency bands for the circuit.

FIG. 28A is a schematic diagram of a eighteenth exemplary PIM control circuit, this example including discrete resistors and capacitors as well as distributed transmission media elements. In this example circuit, the elements designated as L1, L2 and L3 are distributed transmission media elements with impedances and air equivalent lengths that have been determined numerically to produce the frequency response shown in FIG. 28B. Similarly, the capacitance values for the lumped capacitors C1, C2, C3 and C4, as well as the resistance values for the lumped resistors R1 and R2 have also been determined numerically to produce the frequency response shown in FIG. 28B. This example circuit has been included to demonstrate that circuits including additional types of lumped electrical elements, such as capacitors and inductors, may be designed to have desirable frequency response characteristics for PIM control purposes. Those skilled in the art will appreciate that numerical computer simulation programs can be designed, and are generally available, to assist in this design and simulation process. It should also be noted that the example shown in FIGS. 28A-B is designed for PCS frequencies, but a person of ordinary skill in the art will appreciate that the circuit can also be designed to operate at lower frequencies, such as a 450 MHz fundamental band, where it may find a practical application.

FIG. 28B is a graph illustrating the frequency response of the exemplary PIM control circuit shown schematically in FIG. 28A along with the intended fundamental and second harmonic frequency bands for the circuit.

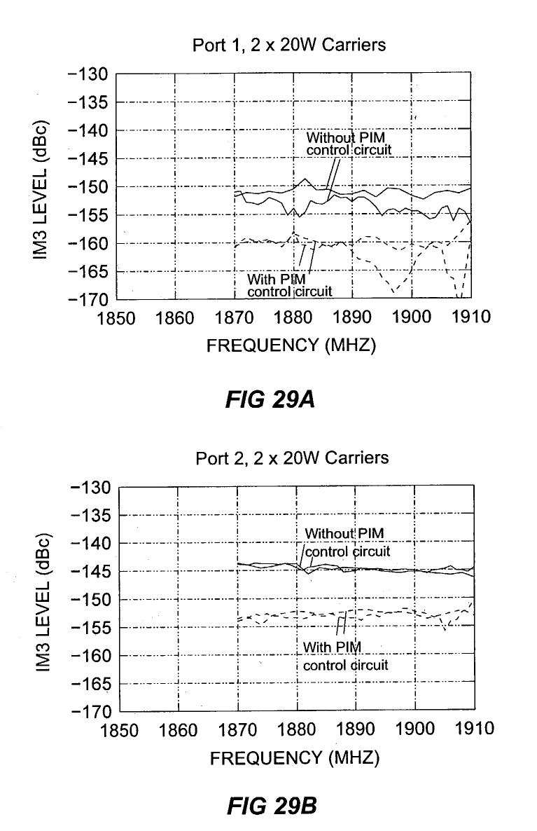

FIG. 29A is a graph illustrating the measured third order intermodulation (IM3) frequency response of the antenna 90 shown in FIGS. 9A-B and 10A-B measured at a first antenna interface 102 with and without the PIM control circuit 96 connected to the antenna feed circuit. This graph corresponds to the second polarity (i.e., vanes 92′) of the dipole antenna array 90. The exemplary antenna including the present invention of a PIM control circuit is a model having the designation RR65-1.7-04PL2 manufactured by EMS Wireless, a division of EMS Technologies, Inc. located in Norcross, Ga. There are two frequency response sweeps or traces for each measurement condition and the measurement conditions are for the antenna “with” (dashed line) and “without” (solid line) the exemplary PIM control circuit. Each measurement is conducted using two tones or carriers at 20 Watts (W) per tone. A first trace corresponds to a fixed frequency tone at 1930 MHz and a second variable frequency tone ranging from 1990 MHz to 1930 MHz. A second trace corresponds to a fixed frequency tone at 1990 MHz and a second variable frequency tone ranging from 1930 MHz to 1990 MHz. The corresponding third (3rd ) order intermodulation (IM3) products span the frequency range of 1870 to 1910 MHz. The vertical scale is the amplitude of the IM3 signal amplitude relative to a carrier power level expressed in decibels (dBc). The measurements indicate a reduction of IM3 signal amplitude of approximately 8 dB by the exemplary PIM control circuit.

FIG. 29B is a graph illustrating the measured third order intermodulation (IM3) frequency response of the antenna array 90 shown in FIGS. 9A-B and 10A-B measured at a second antenna interface (not shown) with and without the PIM control circuit connected to the antenna feed circuit. This graph corresponds to the second polarity (i.e., vanes 92″) of the dipole antenna 90.

In view of the foregoing, it will be appreciated that present invention provides an improved system for suppressing PIM interference in communication systems. It should be understood that the foregoing relates only to the exemplary embodiments of the present invention, and that numerous changes may be made therein without departing from the spirit and scope of the invention as defined by the following claims.

The invention claimed is:

1. In or for a communication system comprising a transmission media carrying a plurality of analog transmission frequencies and at least one reception frequency band, a passive intermodulation interference control circuit comprising:
a plurality of distributed elements of defined length and impedance segments of transmission media that are electrically connected into a circuit having a desired frequency response; and
the circuit being directly connected to the communication system through a continuous extension of the transmission media of the communication system; and
the circuit being configured to control intermodulation interference associated with the transmission frequencies that occur within the reception frequency band.

2. The passive intermodulation interference control circuit of claim 1, wherein the circuit is configured to indirectly control in-band intermodulation interference by directly controlling out-of-band subject frequencies comprising harmonic multiples of the transmission frequencies.

3. The passive intermodulation interference control circuit of claim 1 physically located on a substrate carrying an antenna power divider directing the transmission frequencies carried oh the transmission media to a plurality of antenna elements.

4. The passive intermodulation interference control circuit of claim 3 wherein:
the transmission media comprises microstrip with or without one or more dielectric materials; and
the distributed elements comprise segments of said microstrip having a size and length selected to exhibit desired impedance and phase characteristics.

5. The passive intermodulation interference control circuit of claim 3 wherein the distributed elements comprise segments of transmission media selected from the group consisting essentially of microstrip, air microstrip, stripline, coaxial cable, square-ax cable, and waveguide with or without one or more dielectric materials.

6. The passive intermodulation interference control circuit of claim 1, further comprising one or more discrete electrical elements.

7. The passive intermodulation interference control circuit of claim 1, wherein the distributed elements define a shunt configuration.

8. The passive intermodulation interference control circuit of claim 1, wherein the distributed elements define a diplexer configuration.

9. The passive intermodulation interference control circuit of claim 1, wherein the distributed elements define a multi-leg shunt configuration.

10. The passive intermodulation interference control circuit of claim 1, wherein the distributed elements define a bi-directionally equivalent back-to-back shunt configuration.

11. The passive intermodulation interference control circuit of claim 1, wherein the distributed elements define a bi-directionally equivalent back-to-back diplexer configuration.

12. An antenna system comprising,
a transmission media carrying at least two transmission carrier frequencies and one reception frequency;
a power divider connecting a plurality of antenna elements to the transmission media;
a passive intermodulation interference control circuit connected to the transmission media and configured to indirectly control in-band intermodulation interference associated with the transmission frequencies that occur within the reception frequency band by directly controlling out-of-band subject frequencies comprising harmonic multiples of the transmission frequencies.

13. The antenna system of claim 12, wherein the passive intermodulation interference control circuit comprises a plurality of distributed elements of defined length and impedance segments of transmission media that are electrically connected into a circuit having a desired frequency response.

14. The passive intermodulation interference control circuit of claim 12 physically located on a substrate carrying an antenna power divider directing the transmission frequencies carried on the transmission media to a plurality of antenna elements.

15. The passive intermodulation interference control circuit of claim 12 wherein:
the transmission media comprises microstrip with or without one or more dielectric materials; and
the distributed elements comprise segments of said microstrip having a size and length selected to exhibit desired impedance and phase characteristics.

16. The passive intermodulation interference control circuit of claim 12 wherein the distributed elements comprise segments of transmission media selected from the group consisting essentially of microstrip, stripline, coaxial cable, square-ax cable, and waveguide with or without one or more dielectric materials.

17. The passive intermodulation interference control circuit of claim 12, further comprising one or more discrete electrical elements.

18. The passive intermodulation interference control circuit of claim 12, wherein the distributed elements define a circuit configuration selected from the group consisting essentially of a shunt configuration, a diplexer configuration, a multi-leg shunt configuration, a bi-directionally equivalent back-to-back shunt configuration, and a bi-directionally equivalent back-to-back diplexer configuration.

19. A method for designing a passive intermodulation interference control circuit for a communications system, comprising the steps of:
identifying at least two transmission carrier frequencies for the communications system;
identifying a reception frequency band for the communications system;
identifying in-band intermodulation frequencies associated with the transmission carrier frequencies occurring within the reception band;
identifying out-of-band principal components of the intermodulation frequencies occurring outside the reception band; and
designing a passive intermodulation interference control circuit for indirectly controlling the in-band intermodulation frequencies by directly controlling the out-of-band principal components of the intermodulation frequencies.

20. The method of claim 19, further comprising the step of designing the passive intermodulation interference control circuit to comprise a plurality of distributed elements of defined length and impedance segments of transmission mediamedia that are electrically connected into a circuit having a desired frequency response.

21. The method of claim 20, further comprising the step of designing the passive intermodulation interference control circuit to comprise one or more discrete elements.

22. The method of claim 21, further comprising the step of designing the passive intermodulation interference control circuit to define a circuit configuration selected from the group consisting essentially of a shunt configuration, a diplexer configuration, a multi-leg shunt configuration, a bi-directionally equivalent back-to-back shunt configuration, and a bi-directionally equivalent back-to-back diplexer configuration.

23. In an antenna system comprising a transmission media supplying transmission power in a plurality of transmission frequencies and receiving reception power in a reception frequency band, an improvement comprising:
a passive intermodulation interference suppression circuit directly coupled to the communication system through a continuous extension of the transmission media of the communication system, comprising distributed elements constructed from segments of transmission media, and configured to control harmonic multiples of the transmission frequencies occurring outside the reception band in order to effect reduction of intermodulation interference occurring within the reception band.

24. A passive interference suppression circuit comprising distributed elements constructed from segments of transmission media, and configured to indirectly suppress interference frequencies occurring within a desired band by directly suppressing identified subject components of the interference frequencies occurring outside the desired band.

25. The passive interference suppression circuit of claim 24, wherein:
the interference frequencies comprise intermodulation interference resulting from a plurality of transmission frequencies; and
the subject components comprise harmonic multiples of the transmission frequencies.

26. The passive interference suppression circuit of claim 25 directly connected to a transmission media carrying the transmission and reception frequencies through a continuous extension of the transmission media.

27. A passive interference suppression circuit comprising distributed elements constructed from segments of transmission media, and directly connected to a transmission media carrying transmission and reception frequencies through a continuous extension of the transmission media.

28. The passive interference suppression circuit of claim 27 configured to indirectly suppress interference frequencies occurring within the reception frequency by directly suppressing identified subject components of the interference frequencies occurring outside the desired band comprising harmonic multiples of the transmission frequencies.
